(19) United States
(12) Patent Application Publication
(10) Pub. No.: US 2024/0254602 A1
(43) Pub. Date: Aug. 1, 2024

(54) GRAIN-ORIENTED ELECTRICAL STEEL SHEET

(71) Applicant: NIPPON STEEL CORPORATION, Tokyo (JP)

(72) Inventors: Yoshiyuki USHIGAMI, Tokyo (JP); Shinsuke TAKATANI, Tokyo (JP); Masaru TAKAHASHI, Tokyo (JP); Kazutoshi TAKEDA, Tokyo (JP)

(73) Assignee: NIPPON STEEL CORPORATION, Tokyo (JP)

(21) Appl. No.: 18/564,043

(22) PCT Filed: May 30, 2022
(86) PCT No.: PCT/JP2022/021936

§ 371 Date: Nov. 24, 2023

(30) Foreign Application Priority Data
May 28, 2021 (JP) 2021-090213

(51) Int. Cl. C22C 38/02; C21D 8/12

(52) U.S. Cl. CPC C22C 38/02; C21D 8/1283; C21D 2201/03; C21D 2201/05

(57) ABSTRACT

A grain-oriented electrical steel sheet includes a base steel sheet, an oxide film, and a phosphate-based coating. The phosphate-based coating includes a first crystalline phosphorus oxide whose crystal structure corresponds to Fe₂P₂O₇ and a second crystalline phosphorous oxide whose crystal structure corresponds to Fe₇(P₂O₇)₄, and the second crystalline phosphorous oxide includes at least one element selected from a group consisting of V, W, Zr, Co, and Mo.

### TECHNICAL FIELD

The present invention relates to a grain-oriented electrical steel sheet. In particular, the present invention relates to the grain-oriented electrical steel sheet excellent in adhesion of an insulation coating even without a forsterite film.

Priority is claimed on Japanese Patent Application No. 2021-090213, filed on May 28, 2021, and the content of which is incorporated herein by reference.

### BACKGROUND ART

A grain-oriented electrical steel sheet is used mainly in a transformer. A transformer is continuously excited over a long period of time from installation to disuse such that energy loss continuously occurs. Therefore, energy loss occurring when the transformer is magnetized by an alternating current, that is, iron loss is a main index that determines the performance of the transformer.

In order to reduce iron loss of a grain-oriented electrical steel sheet, various methods have been developed. Examples of the methods include a method of highly aligning grains in the {110}<001> orientation called Goss orientation in a crystal structure, a method of increasing the content of a solid solution element such as Si that increases electric resistance in a steel sheet, and a method of reducing the thickness of a steel sheet.

In addition, it is known that a method of applying tension to a steel sheet is effective for reducing iron loss. Thus, in general, in order to reduce the iron loss, an insulation coating is formed on a surface of the grain-oriented electrical steel sheet. The coating applies the tension to the grain-oriented electrical steel sheet, and thereby, reduces the iron loss as a single steel sheet. Moreover, the coating ensures interlaminar electrical insulation when the grain-oriented electrical steel sheets are utilized after being laminated, and thereby, reduces the iron loss as an iron core.

For instance, as the grain-oriented electrical steel sheet with the coating, a forsterite film which is an oxide film including Mg is formed on a surface of a base steel sheet, and then, the insulation coating is formed on a surface of the forsterite film. In this case, the coating on the base steel sheet includes the forsterite film and the insulation coating. Each of the forsterite film and the insulation coating has both a function of insuring the electrical insulation and applying the tension to the base steel sheet.

The forsterite film is formed, during final annealing in which secondary recrystallization is caused in the steel sheet, by reacting an annealing separator mainly containing magnesia (MgO) with silicon dioxide (SiO₂) formed on the base steel sheet during decarburization annealing, in a heat treatment at 900 to 1200° ° C. for 30 hours or more.

The insulation coating is formed by applying coating solution including, for instance, phosphoric acid or phosphate, colloidal silica, and chromic anhydride or chromate to the steel sheet after final annealing, and by baking and drying it at 300 to 950° ° C. for 10 seconds or more.

In order that the coating performs the functions of ensuring the insulation and applying the tension to the base steel sheet, sufficient adhesion is required between the coating and the base steel sheet.

Conventionally, the above adhesion has been mainly ensured by the anchor effect derived from the unevenness of an interface between the base steel sheet and the forsterite film. However, in recent years, it has been found that the unevenness of the interface becomes an obstacle of movement of a magnetic domain wall when the grain-oriented electrical steel sheet is magnetized, and thus, the unevenness is also a factor that hinders the reduction of iron loss.

For instance, Patent Document 1 and Patent Document 2 disclose a technique to form the insulation coating even in a state in which the surface of the base steel sheet does not have the forsterite thereon and is made to be smooth in order to further reduce the iron loss.

In the method for manufacturing the grain-oriented electrical steel sheet as disclosed in the Patent Document 1, the forsterite film is removed by pickling or the like and then the surface of the base steel sheet is smoothened by chemical polishing or electrolytic polishing. In the method for manufacturing the grain-oriented electrical steel sheet as disclosed in the Patent Document 2, the formation of the forsterite film itself is suppressed by using an annealing separator containing alumina (Al₂O₃) for the final annealing and thereby the surface of the base steel sheet is smoothened.

However, in the manufacturing methods as disclosed in the Patent Document 1 and the Patent Document 2, there is a problem that the insulation coating is difficult to adhere to the surface of the base steel sheet (sufficient adhesion is not obtained) in a case where the insulation coating is formed in contact with the surface of the base steel sheet (directly on the surface of the base steel sheet).

For instance, Patent Document 3 and Patent Document 4 disclose a technique to improve the adhesion of the insulation coating by controlling the state of the insulation coating or by controlling the state of the intermediate layer which is arranged between the base steel sheet and the insulation coating in order to secure the coating adhesion.

In the grain-oriented electrical steel sheet as disclosed in the Patent Document 3, the insulation coating has a crystalline phosphide-containing layer containing a crystalline phosphide. In the grain-oriented electrical steel sheet as disclosed in the Patent Document 4, the intermediate layer has a local oxidized area, and a thickness of the intermediate layer in an area where the local oxidized area is included is 50 nm or more.

### PRIOR ART DOCUMENTS

### Patent Documents

[Patent Document 1] Japanese Unexamined Patent Application, First Publication No. S49-096920
[Patent Document 2] PCT International Publication No. WO2002/088403
[Patent Document 3] PCT International Publication No. WO2019/013353
[Patent Document 4] PCT International Publication No. WO2019/013350

### SUMMARY OF THE INVENTION

### Problem to be Solved by the Invention

As described above, in order to reduce the iron loss of the grain-oriented electrical steel sheet, it is effective to smooth the surface of the base steel sheet of the grain-oriented electrical steel sheet. However, in a case where the surface of the base steel sheet is made to be smooth, the adhesion of the insulation coating deteriorates.

In the techniques disclosed in Patent Document 1 and Patent Document 2, it cannot be said that the coating adhesion is sufficient. In addition, although the coating adhesion is surely improved by the techniques disclosed in Patent Document 3 and Patent Document 4, it is preferable for the grain-oriented electrical steel sheet when the coating adhesion can be further improved.

The present invention has been made in consideration of the above-mentioned situations. An object of the invention is to provide the grain-oriented electrical steel sheet excellent in the adhesion of the insulation coating even without the forsterite film.

### Means for Solving the Problem

An aspect of the present invention employs the following.

(1) A grain-oriented electrical steel sheet according to an aspect of the present invention includes:
a base steel sheet which is a silicon steel sheet;
an intermediate layer arranged in contact with the silicon steel sheet; and
an insulation coating arranged in contact with the intermediate layer,
wherein the intermediate layer is an oxide film satisfying:
20 atomic % or more and 70 atomic % or less of a Si content;
30 atomic % or more and 80 atomic % or less of an O content;
less than 20 atomic % of a Mg content;
less than 5 atomic % of a P content; and
less than 20 atomic % of a Fe content, and
an average thickness of the oxide film is 2 nm or more and 500 nm or less,
wherein the insulation coating is a phosphate-based coating satisfying:
5 atomic % or more and 30 atomic % or less of a P content;
5 atomic % or more and 30 atomic % or less of a Si content;
30 atomic % or more and 80 atomic % or less of an O content;
1 atomic % or more and less than 25 atomic % of a Fe content;
less than 1.0 atomic % of a Cr content;
0 atomic % or more and 10 atomic % or less of an Al content;
0 atomic % or more and 10 atomic % or less of a Mg content;
0 atomic % or more and 10 atomic % or less of a Mn content;
0 atomic % or more and 10 atomic % or less of a Ni content;
0 atomic % or more and 10 atomic % or less of a Zn content;
0.1 atomic % or more and 10 atomic % or less in total content of Al, Mg, Mn, Ni, and Zn;
0 atomic % or more and 10 atomic % or less of a V content;
0 atomic % or more and 10 atomic % or less of a W content;
0 atomic % or more and 10 atomic % or less of a Zr content;
0 atomic % or more and 10 atomic % or less of a Co content;
0 atomic % or more and 10 atomic % or less of a Mo content; and
0.1 atomic % or more and 10 atomic % or less in total content of V, W, Zr, Co, and Mo, and
an average thickness of the phosphate-based coating is 0.1 μm or more and 10 μm or less, and
wherein the phosphate-based coating includes a first crystalline phosphorus oxide whose crystal structure corresponds to Fe₂P₂O₇ and a second crystalline phosphorous oxide whose crystal structure corresponds to Fe₇(P₂O₇)₄, and
the second crystalline phosphorous oxide includes at least one element selected from a group consisting of V, W, Zr, Co, and Mo.

(2) In the grain-oriented electrical steel sheet according to (1),
when the phosphate-based coating is divided along a thickness direction on a cross section whose cutting direction is parallel to the thickness direction into two equal regions which are an internal region in contact with the oxide film and a surface region not in contact with the oxide film,
a total area fraction of the first crystalline phosphorus oxide and the second crystalline phosphorous oxide which are included in the internal region may be more than a total area fraction of the first crystalline phosphorus oxide and the second crystalline phosphorous oxide which are included in the surface region.

(3) In the grain-oriented electrical steel sheet according to (1) or (2),
the total area fraction of the first crystalline phosphorus oxide and the second crystalline phosphorous oxide which are included in the surface region may be 0% or more and 30% or less, and the total area fraction of the first crystalline phosphorus oxide and the second crystalline phosphorous oxide which are included in the internal region may be 3% or more and 50% or less.

(4) In the grain-oriented electrical steel sheet according to any one of (1) to (3),
when the internal region is divided along the thickness direction on the cross section into two equal regions which are a first internal region in contact with the oxide film and a second internal region not in contact with the oxide film,
when a first area ratio is set as a percentage of a value obtained by dividing an area fraction of the second crystalline phosphorous oxide which is included in the first internal region by a total area fraction of the first crystalline phosphorus oxide and the second crystalline phosphorous oxide which are included in the first internal region, and
when a second area ratio is set as a percentage of a value obtained by dividing an area fraction of the second crystalline phosphorous oxide which is included in the second internal region by a total area fraction of the first crystalline phosphorus oxide and the second crystalline phosphorous oxide which are included in the second internal region,
the second area ratio may be more than the first area ratio.

(5) In the grain-oriented electrical steel sheet according to any one of (1) to (4),
the first area ratio is 0% or more and 70% or less and the second area ratio may be 50% or more and 100% or less.

(6) In the grain-oriented electrical steel sheet according to any one of (1) to (5),
an equivalent circle diameter of the second crystalline phosphorous oxide may be 5 nm or more and 300 nm or less on average.

### Effects of the Invention

According to the above aspects of the present invention, it is possible to provide the grain-oriented electrical steel sheet excellent in the adhesion of the insulation coating even without the forsterite film.

### BRIEF DESCRIPTION OF DRAWINGS

FIG. 1 is a cross-sectional illustration showing a layering structure of a grain-oriented electrical steel sheet according to an embodiment of the present invention.

FIG. 2 is a cross-sectional illustration showing a layering structure of a grain-oriented electrical steel sheet according to a preferred embodiment of the present invention.

FIG. 3 is a flow chart illustrating a method for manufacturing a grain-oriented electrical steel sheet according to an embodiment of the present invention.

### EMBODIMENTS FOR IMPLEMENTING THE INVENTION

Hereinafter, a preferable embodiment of the present invention is described in detail. However, the present invention is not limited only to the configuration which is disclosed in the embodiment, and various modifications are possible without departing from the aspect of the present invention. In addition, the limitation range as described below includes a lower limit and an upper limit thereof. However, the value expressed by “more than” or “less than” does not include in the limitation range. Unless otherwise noted, “%” of the amount of respective elements expresses “mass %” for a base steel sheet and “atomic %” for an intermediate layer and an insulation coating.

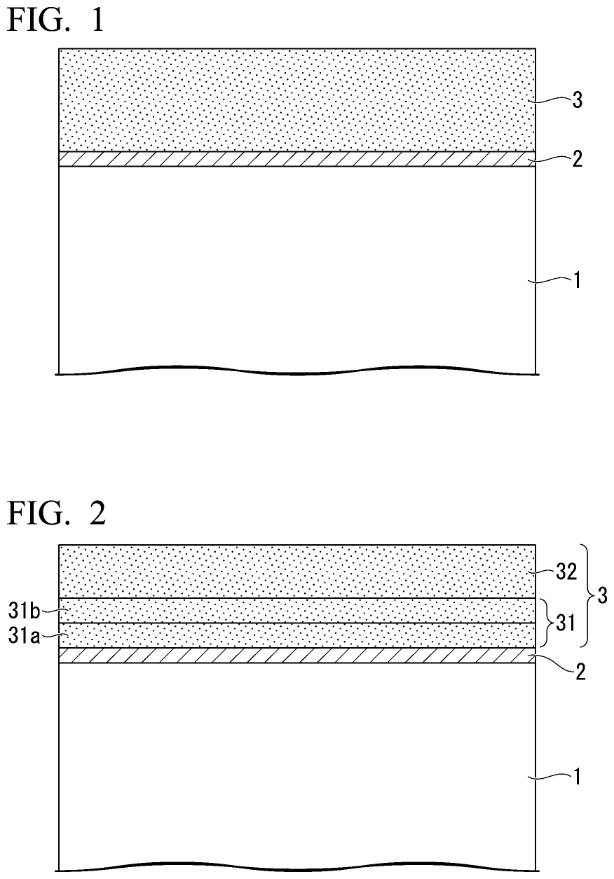

FIG. 1 is a cross-sectional illustration showing a layering structure of a grain-oriented electrical steel sheet according to an embodiment of the present invention. As shown in FIG. 1, when viewing a cross section whose cutting direction is parallel to thickness direction, the grain-oriented electrical steel sheet according to the embodiment does not include the forsterite film on the surface of the base steel sheet 1 but includes the intermediate layer 2 which mainly contains the silicon oxide and which is arranged on the surface of the base steel sheet 1 and includes the insulation coating 3 which is derived from the phosphate and the colloidal silica and which is arranged on the intermediate layer 2.

Specifically, the grain-oriented electrical steel sheet according to the embodiment includes:
a base steel sheet which is a silicon steel sheet;
an intermediate layer arranged in contact with the silicon steel sheet; and
an insulation coating arranged in contact with the intermediate layer,
wherein the intermediate layer is an oxide film satisfying:
20 atomic % or more and 70 atomic % or less of a Si content;
30 atomic % or more and 80 atomic % or less of an O content;
less than 20 atomic % of a Mg content;
less than 5 atomic % of a P content; and
less than 20 atomic % of a Fe content, and
an average thickness of the oxide film is 2 nm or more and 500 nm or less,
wherein the insulation coating is a phosphate-based coating satisfying:
5 atomic % or more and 30 atomic % or less of a P content;
5 atomic % or more and 30 atomic % or less of a Si content;
30 atomic % or more and 80 atomic % or less of an O content;
1 atomic % or more and less than 25 atomic % of a Fe content;
less than 1.0 atomic % of a Cr content;
0 atomic % or more and 10 atomic % or less of an Al content;
0 atomic % or more and 10 atomic % or less of a Mg content;
0 atomic % or more and 10 atomic % or less of a Mn content;
0 atomic % or more and 10 atomic % or less of a Ni content;
0 atomic % or more and 10 atomic % or less of a Zn content;
0.1 atomic % or more and 10 atomic % or less in total content of Al, Mg, Mn, Ni, and Zn;
0 atomic % or more and 10 atomic % or less of a V content;
0 atomic % or more and 10 atomic % or less of a W content;
0 atomic % or more and 10 atomic % or less of a Zr content;
0 atomic % or more and 10 atomic % or less of a Co content;
0 atomic % or more and 10 atomic % or less of a Mo content; and
0.1 atomic % or more and 10 atomic % or less in total content of V, W, Zr, Co, and Mo, and
an average thickness of the phosphate-based coating is 0.1 μm or more and 10 μm or less, and
wherein the phosphate-based coating includes a first crystalline phosphorus oxide whose crystal structure corresponds to Fe₂P₂O₇ and a second crystalline phosphorous oxide whose crystal structure corresponds to Fe₇(P₂O₇)₄, and
the second crystalline phosphorous oxide includes at least one element selected from a group consisting of V, W, Zr, Co, and Mo.

As described above, in the grain-oriented electrical steel sheet according to the embodiment, the intermediate layer is not the forsterite film but the Si based oxide film, the insulation coating is the phosphate-based coating, and the phosphate-based coating includes the first crystalline phosphorus oxide and the second crystalline phosphorous oxide, which are the main technical features.

Hereinafter, each feature is described in detail. First, the phosphate-based coating of the grain-oriented electrical steel sheet according to the embodiment is described.

### Phosphate-Based Coating

The phosphate-based coating is arranged at the outermost surface in the layering structure of the grain-oriented electrical steel sheet. The phosphate-based coating is formed on the base steel sheet at high temperature using the material having a smaller coefficient of thermal expansion than that of the base steel sheet. A difference in shrinkage occurs between the phosphate-based coating and the base steel sheet during cooling, and as a result, the phosphate-based coating applies tension to the base steel sheet. In a case where the tension is applied to the base steel sheet in the grain-oriented electrical steel sheet, the iron loss characteristics are favorably improved.

In order for the phosphate-based coating to apply the tension to the base steel sheet, it is important that the phosphate-based coating and the base steel plate adhere to each other. In the grain-oriented electrical steel sheet according to the embodiment, in order to improve the coating adhesion, the composition and thickness of the phosphate-based coating is controlled, and the plural crystalline phosphorus oxides are included in the phosphate-based coating.

The composition of the phosphate-based coating is described below.

In the grain-oriented electrical steel sheet according to the embodiment, the phosphate-based coating includes, as the coating composition, base elements and optional elements as necessary. In addition, it is preferable that the balance of the base elements and the optional elements consists of impurities.

Specifically, the phosphate-based coating may satisfy: as the base elements,
5 atomic % or more and 30 atomic % or less of a P content;
5 atomic % or more and 30 atomic % or less of a Si content;
30 atomic % or more and 80 atomic % or less of an O content; and
1 atomic % or more and less than 25 atomic % of a Fe content.
Moreover, the phosphate-based coating may satisfy: as the optional elements,
0 atomic % or more and 10 atomic % or less of an Al content;
0 atomic % or more and 10 atomic % or less of a Mg content;
0 atomic % or more and 10 atomic % or less of a Mn content;
0 atomic % or more and 10 atomic % or less of a Ni content;
0 atomic % or more and 10 atomic % or less of a Zn content;
0.1 atomic % or more and 10 atomic % or less in total content of Al, Mg, Mn, Ni, and Zn;
0 atomic % or more and 10 atomic % or less of a V content;
0 atomic % or more and 10 atomic % or less of a W content;
0 atomic % or more and 10 atomic % or less of a Zr content;
0 atomic % or more and 10 atomic % or less of a Co content;
0 atomic % or more and 10 atomic % or less of a Mo content; and
0.1 atomic % or more and 10 atomic % or less in total content of V, W, Zr, Co, and Mo.

Moreover, the phosphate-based coating may satisfy, as the impurities,
less than 1.0 atomic % of a Cr content.

In general, the phosphate-based coating of the grain-oriented electrical steel sheet is formed by baking the coating solution including phosphate, colloidal silica, and chromate. The chromate is included in order to improve corrosion resistance, improve chemical resistance, and suppress voids.

On the other hand, the phosphate-based coating of the grain-oriented electrical steel sheet according to the embodiment is formed by baking the coating solution including phosphate and colloidal silica but not including chromate. Thus, as described above, in the phosphate-based coating of the grain-oriented electrical steel sheet according to the embodiment, the Cr content is limited to less than 1.0 atomic %. The content is preferably 0.8 atomic % or less, and is more preferably 0.5 atomic % or less.

In the grain-oriented electrical steel sheet according to the embodiment, limiting the Cr content in the phosphate-based coating to less than 1.0 atomic % is one of the control conditions for forming the above first crystalline phosphorus oxide and the above second crystalline phosphorous oxide in the phosphate-based coating. The conditions for forming these crystalline phosphorus oxides are described later in detail.

P, Si, O, and Fe, which are the base elements of the above phosphate-based coating, are derived from the phosphate and the colloidal silica contained in the coating solution, the oxidation reaction during baking treatment, the elements diffused from the base steel sheet, or the like. Moreover, Al, Mg, Mn, Ni, Zn, V, W, Zr, Co, and Mo, which are optional elements of the above phosphate-based coating, are derived from the phosphate contained in the coating solution. For instance, at least one phosphate selected from the group consisting of Al, Mg, Mn, Ni, Zn, V, W, Zr, Co, and Mo may be used as the phosphate contained in the coating solution. Preferably, at least one phosphate selected from the group consisting of Al, Mg, Mn, Ni, and Zn may be used as the phosphate contained in the coating solution, and the phosphate-based coating may satisfy, as the coating composition, 0.1 atomic % or more and 10 atomic % or less in total content of Al, Mg, Mn, Ni, and Zn. For instance, the aluminum phosphate may be used as the phosphate contained in the coating solution, and the phosphate-based coating may satisfy, as the coating composition, 0.1 atomic % or more and 10 atomic % or less of the Al content. Moreover, at least one phosphate selected from the group consisting of Co, Mo, V, W, and Zr may be used as the phosphate contained in the coating solution, and the phosphate-based coating may satisfy, as the coating composition, 0.1 atomic % or more and 10 atomic % or less in total content of V, W, Zr, Co, and Mo. Moreover, the above Cr is the impurity of the phosphate-based coating. The impurity is derived from the elements which are contaminated from raw materials and environment for forming the phosphate-based coating or the elements which diffuse from the base steel sheet. The lower limit of the impurity content is not particularly limited. The content thereof is preferably lower, and may be 0%.

In the grain-oriented electrical steel sheet according to the embodiment, in order to improve the coating adhesion, the composition of the phosphate-based coating may satisfy the above conditions. In particular, the Cr content of the phosphate-based coating is limited to less than 1.0 atomic %.

In addition, in the grain-oriented electrical steel sheet according to the embodiment, as the composition of the phosphate-based coating (average coating composition), the P content is preferably more than 8 atomic % and preferably less than 17 atomic %, the Si content is preferably more than 7 atomic % and preferably less than 19 atomic %, the O content is preferably more than 58 atomic % and preferably less than 66 atomic %, the Fe content is preferably more than 1 atomic % and preferably less than 20 atomic %, the Cr content is preferably less than 0.2 atomic %, the Al content is preferably less than 10 atomic % and preferably less than 3 atomic %, the Mg content is preferably less than 10 atomic % and preferably less than 3 atomic %, the Mn content is preferably less than 10 atomic % and preferably less than 3 atomic %, the Ni content is preferably less than 10 atomic % and preferably less than 3 atomic %, the Zn content is preferably less than 10 atomic % and preferably less than 3 atomic %, the total amount of Al, Mg, Mn, Ni, and Zn is preferably 0.1 atomic % or more, preferably more than 1 atomic %, preferably less than 10 atomic %, and preferably less than 3 atomic %, the V content is preferably less than 3.0 atomic % and preferably less than 2 atomic %, the W content is preferably less than 3.0 atomic % and preferably less than 2 atomic %, the Zr content is preferably less than 3.0 atomic % and preferably less than 2 atomic %, the Co content is preferably less than 3.0 atomic % and preferably less than 2 atomic %, the Mo content is preferably less than 3.0 atomic % and preferably less than 2 atomic %, or the total amount of V, W, Zr, Co, and Mo is preferably 0.1 atomic % or more, preferably 0.2 atomic % or more, preferably less than 3.0 atomic %, and preferably less than 2 atomic %.

In order to measure the composition of the phosphate-based coating, composition analysis may be conducted on the cross section using SEM-EDS (Scanning Electron Microscope-Energy Dispersive X-ray Spectroscopy) or TEM-EDS (Transmission Electron Microscope-Energy Dispersive X-ray Spectroscopy). The method for measuring the coating composition is described later in detail.

The thickness of the phosphate-based coating is described below.

In the grain-oriented electrical steel sheet according to the embodiment, when viewing the cross section whose cutting direction is parallel to thickness direction, the average thickness of the phosphate-based coating is 0.1 μm or more and 10 μm or less.

When the average thickness of the phosphate-based coating is less than 0.1 μm, it is difficult to apply the predetermined tension to the base steel sheet. Thus, the average thickness is preferably 0.1 μm or more, and more preferably 0.5 μm or more.

On the other hand, when the average thickness of the phosphate-based coating is more than 10 μm, cracks may occur in the phosphate-based coating during forming the phosphate-based coating. Thus, the average thickness is preferably 10 μm or less, and more preferably 5 μm or less.

In order to measure the average thickness of the phosphate-based coating, line analysis may be conducted on the cross section using SEM-EDS or TEM-EDS. The method for measuring the average thickness is described later in detail.

The crystalline phosphorus oxides included in the phosphate-based coating are described below.

In the grain-oriented electrical steel sheet according to the embodiment, the phosphate-based coating includes the first crystalline phosphorus oxide whose crystal structure corresponds to Fe₂P₂O₇ and the second crystalline phosphorous oxide whose crystal structure corresponds to Fe₇(P₂O₇)₄.

When the phosphate-based coating includes the first crystalline phosphorus oxide and the second crystalline phosphorous oxide, the coating adhesion is improved. The detailed reason is not clear at present, but the following mechanism is considered. It seems that, when the crystalline phosphorous oxides are included in the amorphous phosphate-based coating, the elasticity of the phosphate-based coating increases totally, the stress accumulated in the phosphate-based coating and the oxide film which is the intermediate layer is relieved without concentration locally even under bending stress, and as a result, the phosphate-based coating becomes difficult to delaminate. In particular, it is considered that the second crystalline phosphorus oxide contributes to the above effect remarkably.

In order to form the first crystalline phosphorus oxide and the second crystalline phosphorous oxide in the phosphate-based coating, it is necessary to satisfy the following three conditions.

(1) The intermediate layer is not the forsterite film but the Si based oxide film.

(II) The phosphate-based coating satisfies, as the coating composition, less than 1.0 atomic % of a Cr content.

(III) The forming conditions are controlled during forming the phosphate-based coating.

Only when all of these three conditions are satisfied, both the first crystalline phosphorus oxide and the second crystalline phosphorous oxide are formed in the phosphate-based coating.

First, as the condition (I), it is important that the intermediate layer is not the forsterite film but the Si based oxide film. When the intermediate layer is the forsterite film, in addition that the problem of the coating adhesion does not originally arise, the crystalline phosphorus oxides are not formed in the phosphate-based coating.

The reason why the crystalline phosphorus oxides are not formed in the phosphate-based coating when the intermediate layer is the forsterite film is not clear at present, but the following cause is considered. For instance, it seems that, when the intermediate layer is the forsterite film, the Fe content in the phosphate-based coating decreases, Fe continues to be in the state of solid solution in the phosphate-based coating because the hydrogen content is low in the atmosphere during baking treatment, and as a result, the crystalline phosphorus oxides are not formed in the phosphate-based coating.

Next, as the condition (II), it is important that the Cr content is less than 1.0 atomic % as the composition of the phosphate-based coating. When the Cr content in the phosphate-based coating is 1.0 atomic % or more, the second crystalline phosphorous oxide is not formed in the phosphate-based coating even if the first crystalline phosphorus oxide is formed.

The reason why the second crystalline phosphorous oxide is not formed in the phosphate-based coating when the Cr content in the phosphate-based coating is 1.0 atomic % or more is not clear at present, but the following cause is considered. When the Cr content in the phosphate-based coating is 1.0 atomic % or more, (Fe, Cr)₂P₂O₇ is formed in the phosphate-based coating. The (Fe, Cr)₂P₂O₇ tends to be preferentially formed. Thus, under the condition such that the (Fe, Cr)₂P₂O₇ is formed in the phosphate-based coating, the (Fe, Cr)₂P₂O₇ is preferentially formed, and the crystalline phosphorous oxide whose crystal structure corresponds to Fe₇(P₂O₇)₄ is difficult to be formed.

On the other hand, when the Cr content in the phosphate-based coating is less than 1.0 atomic %, the (Fe, Cr)₂P₂O₇ is not formed in the phosphate-based coating, and alternatively the Fe₂P₂O₇ is formed. However, the Fe₂P₂O₇ is not preferentially formed. Thus, under the condition such that the Fe₂P₂O₇ is formed in the phosphate-based coating, the crystalline phosphorous oxide whose crystal structure corresponds to Fe₂P₂O₇ is formed, and also, the crystalline phosphorous oxide whose crystal structure corresponds to Fe₇(P₂O₇)₄ is formed.

Finally, as the condition (III), it is important that the forming conditions are controlled during forming the phosphate-based coating. When the forming conditions are not preferably controlled during forming the phosphate-based coating, the crystalline phosphorous oxide, especially the second crystalline phosphorous oxide, is not formed even if the condition (I) and the condition (II) are satisfied in the phosphate-based coating.

Specifically, as forming conditions during forming the phosphate-based coating, it is important that the atmosphere and the oxidation degree during baking treatment are controlled, and also, the atmosphere, the oxidation degree, and the cooling rate during cooling after baking treatment are controlled. The manufacturing method is described later in detail.

The existence of the first crystalline phosphorus oxide and the second crystalline phosphorous oxide may be confirmed using TEM. For instance, the electron beam diffraction is performed on the phosphate-based coating, the crystal structure of crystalline phase included in the electron beam irradiated area is identified from the electron beam diffraction pattern, and then, it is confirmed whether or not the first crystalline phosphorus oxide whose crystal structure corresponds to Fe₂P₂O₇ and the second crystalline phosphorous oxide whose crystal structure corresponds to Fe₇(P₂O₇)₄ are included. The method for identifying the crystalline phosphorus oxide is described later in detail.

In the grain-oriented electrical steel sheet according to the embodiment, when both the first crystalline phosphorus oxide and the second crystalline phosphorous oxide are included in the phosphate-based coating, the coating adhesion is improved. Thus, the composition, morphology, and size of the crystalline phosphorus oxide are not particularly limited. However, in order to favorably improve the coating adhesion, it is preferable that the composition, morphology, and size of the crystalline phosphorus oxide satisfy the following features.

In the grain-oriented electrical steel sheet according to the embodiment, it is preferable that the phosphate-based coating satisfies, as the coating composition, 0.1 atomic % or more and 10 atomic % or less in total content of V, W, Zr, Co, and Mo and that the second crystalline phosphorous oxide includes at least one element selected from the group consisting of V, W, Zr, Co, and Mo.

When the phosphate-based coating satisfies, as the coating composition, 0.1 atomic % or more and 10 atomic % or less in total content of V, W, Zr, Co and Mo and when the above conditions (I) to (III) are satisfied, (Fe, M)₇(P₂O₇)₄ as the second crystalline phosphorous oxide whose crystal structure corresponds to Fe₂(P₂O₇)₄ tends to be formed. Herein, the above M corresponds to at least one element selected from the group consisting of V, W, Zr, Co, and Mo.

When the (Fe, M)₇(P₂O₇)₄ is formed and, for instance, when the elemental analysis is performed by irradiating the precipitate with the electron beam, V, W, Zr, Co, or Mo, which are included as coating composition in the phosphate-based coating, are detected as a peak corresponding to the element in the EDS spectrum, and thus, seem to be included as M of the (Fe, M)₇(P₂O₇)₄. In the case, the number of the formed second crystalline phosphorous oxides increases, and also, the influence of the formed individual second crystalline phosphorous oxides on the coating adhesion increases favorably. As a result, the coating adhesion is favorably improved.

Moreover, in the grain-oriented electrical steel sheet according to the embodiment, it is preferable that, when viewing the cross section whose cutting direction is parallel to thickness direction and when the phosphate-based coating is divided into two equal regions which are an internal region in contact with the oxide film and a surface region not in contact with the oxide film, a total area fraction of the first crystalline phosphorus oxide and the second crystalline phosphorous oxide which are included in the internal region is more than a total area fraction of the first crystalline phosphorus oxide and the second crystalline phosphorous oxide which are included in the surface region.

It seems that, when the first crystalline phosphorus oxide and the second crystalline phosphorous oxide are more included in the internal region than the surface region in the phosphate-based coating, the elasticity of the phosphate-based coating favorably increases totally, the stress is favorably relieved even under bending stress, and as a result, the phosphate-based coating becomes difficult to delaminate.

For instance, it is preferable that the total area fraction of the first crystalline phosphorus oxide and the second crystalline phosphorous oxide which are included in the surface region is 0% or more and 30% or less, and the total area fraction of the first crystalline phosphorus oxide and the second crystalline phosphorous oxide which are included in the internal region is 3% or more and 50% or less.

When the first crystalline phosphorus oxide and the second crystalline phosphorous oxide are more included in the internal region than the surface region in the phosphate-based coating and when the total area fractions of the first crystalline phosphorus oxide and the second crystalline phosphorous oxide are within the above ranges, the elasticity of the phosphate-based coating favorably increases totally, and the coating adhesion is more favorably improved.

Moreover, in the grain-oriented electrical steel sheet according to the embodiment, it is preferable that,
when viewing the cross section whose cutting direction is parallel to thickness direction and when the internal region is divided into two equal regions which are a first internal region in contact with the oxide film and a second internal region not in contact with the oxide film,
when a first area ratio is set as a percentage of a value obtained by dividing an area fraction of the second crystalline phosphorous oxide which is included in the first internal region by a total area fraction of the first crystalline phosphorus oxide and the second crystalline phosphorous oxide which are included in the first internal region, and
when a second area ratio set as is a percentage of a value obtained by dividing an area fraction of the second crystalline phosphorous oxide which is included in the second internal region by a total area fraction of the first crystalline phosphorus oxide and the second crystalline phosphorous oxide which are included in the second internal region,
the second area ratio is more than the first area ratio.

When the second crystalline phosphorous oxide is more included in the second internal region than the first internal region in the internal region, the elasticity of the phosphate-based coating favorably increases totally, the stress is favorably relieved even under bending stress, and as a result, the phosphate-based coating becomes difficult to delaminate.

For instance, it is preferable that the first area ratio is 0% or more and 70% or less and the second area ratio is 50% or more and 100% or less.

When the second crystalline phosphorous oxide is more included in the second internal region than the first internal region in the internal region and when the second area ratio is within the above range, the elasticity of the phosphate-based coating further favorably increases totally, and the coating adhesion is more favorably improved.

FIG. 2 is a cross-sectional illustration showing a layering structure of a grain-oriented electrical steel sheet according to a preferred embodiment of the present invention. In FIG. 2, the surface region 32, the internal region 31, the first internal region 31a, and the second internal region 31b in the phosphate-based coating 3 (insulation coating 3) are illustrated.

Moreover, in the grain-oriented electrical steel sheet according to the embodiment, it is preferable that, an equivalent circle diameter of the second crystalline phosphorous oxide is 5 nm or more and 300 nm or less on average.

When the equivalent circle diameter of the second crystalline phosphorous oxide is within the above range, the influence of the second crystalline phosphorous oxides on the coating adhesion increases favorably. As a result, the coating adhesion is favorably improved. The equivalent circle diameter of the second crystalline phosphorous oxide is preferably 20 nm or more, and preferably 220 nm or less.

The existence of V, W, Zr, Co, or Mo in the crystalline phosphorous oxide, the location and area fraction of the crystalline phosphorous oxide, and the equivalent circle diameter of the crystalline phosphorous oxide may be measured using SEM-EDS or TEM-EDS. The measuring methods are described later in detail.

Next, the oxide film which is the intermediate layer of the grain-oriented electrical steel sheet according to the embodiment is described.

### Oxide Film

The oxide film is arranged between the phosphate-based coating and the base steel sheet in the layering structure of the grain-oriented electrical steel sheet. The oxide film is not the forsterite film but the Si based oxide film and has the function of adhering the phosphate-based coating and the base steel sheet.

The composition of the oxide film is described below.

In the grain-oriented electrical steel sheet according to the embodiment, the oxide film includes, as the layer composition, base elements and optional elements as necessary. In addition, it is preferable that the balance of the base elements and the optional elements consists of impurities.

Specifically, the oxide film may satisfy: as the base elements,
20 atomic % or more and 70 atomic % or less of a Si content; and
30 atomic % or more and 80 atomic % or less of an O content.

Moreover, the oxide film may include constituent elements of the base steel sheet as the optional elements, and the total amount thereof may be 0.1 atomic % or more and 20 atomic % or less.

Moreover, the oxide film may satisfy: as the impurities,
less than 20 atomic % of a Mg content;
less than 5 atomic % of a P content; and
less than 20 atomic % of a Fe content.

In general, in the grain-oriented electrical steel sheet, the forsterite film (film which mainly includes Mg₂SiO₄) is formed as the intermediate layer by applying an annealing separator mainly composed of MgO to the decarburization annealed steel sheet and thereafter final-annealing the steel sheet.

When the forsterite film is formed, the coating adhesion is ensured by the anchor effect derived from the unevenness of the interface between the base steel sheet and the forsterite film. However, the unevenness of the interface becomes the obstacle of movement of the magnetic domain wall when the grain-oriented electrical steel sheet is magnetized, and thus, the iron loss characteristics are adversely affected.

In the grain-oriented electrical steel sheet according to the embodiment, the forsterite film is made not to exist, and the interface between the intermediate layer and the base steel sheet is made to be smooth. In addition to controlling the interface to be smooth, the first crystalline phosphorus oxide and the second crystalline phosphorous oxide are formed in the phosphate-based coating by satisfying the above conditions (I) to (III) in order to improve the coating adhesion. As explained in the above condition (I), it is necessary to control the intermediate layer not to be the forsterite film but to be the Si based oxide film.

Thus, as described above, in the oxide film (intermediate layer) of the grain-oriented electrical steel sheet according to the embodiment, Mg content is limited to less than 20 atomic %. The Mg content is preferably 15 atomic % or less, and more preferably 10 atomic % or less. The control conditions not to form the forsterite film but to form the oxide film (intermediate layer) are described later in detail.

Si and O, which are the base elements of the above oxide film, are derived from the constituent elements of the base steel sheet and the oxidation reaction during forming the oxide film. Moreover, the above Mg, P, and Fe are the impurities of the oxide film. The impurities are derived from the elements which are contaminated from raw materials and environment or the elements which diffuse from the base steel sheet or the phosphate-based coating. The lower limits of the impurities content are not particularly limited. The contents thereof are preferably lower, and may be 0%.

In addition, in the grain-oriented electrical steel sheet according to the embodiment, as the composition of the oxide film (average film composition), the Si content is preferably more than 26 atomic % and preferably less than 44 atomic %, the O content is preferably more than 38 atomic % and preferably less than 68 atomic %, the Mg content is preferably less than 20 atomic %, P content is preferably less than 5 atomic %, or the Fe content is preferably less than 20 atomic %.

As with the composition of the phosphate-based coating, in order to measure the composition of the oxide film, the composition analysis may be conducted on the cross section using SEM-EDS or TEM-EDS. The method for measuring the layer composition is described later in detail.

The thickness of the oxide film is described below.

In the grain-oriented electrical steel sheet according to the embodiment, when viewing the cross section whose cutting direction is parallel to thickness direction, the average thickness of the oxide film is 2 nm or more and 500 nm or less.

When the average thickness of the oxide film is less than 2 nm, the thermal stress relaxation effect is not sufficiently obtained. Thus, the average thickness is preferably 2 nm or more, and more preferably 5 nm or more.

On the other hand, when the average thickness of the oxide film is more than 500 nm, the thickness becomes uneven, and defects such as voids and cracks are formed in the film. Thus, the average thickness is preferably 500 nm or less, and more preferably 400 nm or less.

As with the average thickness of the phosphate-based coating, in order to measure the average thickness of the oxide film, line analysis may be conducted on the cross section using SEM-EDS or TEM-EDS. The method for measuring the average thickness is described later in detail.

Next, the base steel sheet of the grain-oriented electrical steel sheet according to the embodiment is described.

### Base Steel Sheet

The base steel sheet is the base material of the grain-oriented electrical steel sheet and is the silicon steel sheet. In the silicon steel sheet, the Si content may be 0.8 mass % or more and 7.0 mass % or less, and the crystal orientation may be controlled to be the {110}<001> orientation (Goss orientation).

Herein, the {110}<001> orientation represents that {110} plane of the crystal is aligned parallel to a rolled surface and <001> axis of the crystal is aligned parallel to a rolling direction.

The steel composition of the silicon steel sheet is described below.

In the grain-oriented electrical steel sheet according to the embodiment, since the steel composition of the silicon steel sheet does not directly influence the existence of the first crystalline phosphorus oxide and the second crystalline phosphorous oxide in the phosphate-based coating, the steel composition of the silicon steel sheet is not particularly limited. Hereinafter, the preferable steel composition of the silicon steel sheet for the grain-oriented electrical steel sheet is described. “%” of the steel composition of the silicon steel sheet represents “mass %”.

The silicon steel sheet may include, as the chemical composition, base elements, optional elements as necessary, and a balance consisting of Fe and impurities.

Specifically, the silicon steel sheet may include, as the chemical composition, by mass %,
0.8% or more and 7.0% or less of Si,
0% or more and 1.00% or less of Mn,
0% or more and 0.30% or less of Cr,
0% or more and 0.40% or less of Cu,
0% or more and 0.50% or less of P,
0% or more and 0.30% or less of Sn,
0% or more and 0.30% or less of Sb,
0% or more and 1.00% or less of Ni,
0% or more and 0.008% or less of B,
0% or more and 0.15% or less of V,
0% or more and 0.2% or less of Nb,
0% or more and 0.10% or less of Mo,
0% or more and 0.015% or less of Ti,
0% or more and 0.010% or less of Bi,
0% or more and 0.005% or less of Al,
0% or more and 0.005% or less of C,
0% or more and 0.005% or less of N,
0% or more and 0.005% or less of S,
0% or more and 0.005% or less of Se, and
a balance consisting of Fe and impurities.

In the embodiment, the silicon steel sheet may include Si as the base elements (main alloying elements).
0.8% or more and 7.0% or less of Si

Si (silicon) as the chemical composition of the silicon steel sheet is the element effective in increasing the electric resistance and reducing the iron loss. When the Si content is more than 7.0%, the steel sheet may crack easily during cold rolling and the rolling may be difficult to be conducted. On the other hand, when the Si content is less than 0.8%, the electric resistance may decrease, and the iron loss of the product may increase. Thus, 0.8% or more and 7.0% or less of Si may be included. The lower limit of Si content is preferably 2.0%, more preferably 2.5%, and further more preferably 2.8%. The upper limit of Si content is preferably 5.0%, and more preferably 3.5%.

In the embodiment, the silicon steel sheet may include the impurities. The impurities correspond to elements which are contaminated during industrial manufacture of steel from ores and scrap that are used as a raw material of steel, or from environment of a manufacturing process or the like.

Moreover, in the embodiment, the silicon steel sheet may include the optional elements in addition to the base elements and the impurities. For instance, as a substitution for a part of Fe which is the balance, the silicon steel sheet may include the optional elements such as Mn, Cr, Cu, P, Sn, Sb, Ni, B, V, Nb, Mo, Ti, Bi, Al, C, N, S, or Se. The optional elements may be included depending on the purposes. Thus, a lower limit of the respective optional elements does not need to be limited, and the lower limit may be 0%. Moreover, even if the optional elements may be included as impurities, the above-mentioned effects are not affected.
0% or more and 1.00% or less of Mn

As with Si, Mn (manganese) is the element effective in increasing the electric resistance and reducing the iron loss. Moreover, Mn act as the inhibitor by bonding to S or Se. Thus, 1.00% or less of Mn may be included. The lower limit of Mn content is preferably 0.05%, more preferably 0.08%, and further more preferably 0.09%. The upper limit of Mn content is preferably 0.50%, and more preferably 0.20%.
0% or more and 0.30% or less of Cr

As with Si, Cr (chrome) is the element effective in increasing the electric resistance and reducing the iron loss. Thus, 0.30% or less of Cr may be included. The lower limit of Cr content is preferably 0.02%, and more preferably 0.05%. The upper limit of Cr content is preferably 0.20%, and more preferably 0.12%.
0% or more and 0.40% or less of Cu

Cu (copper) is also the element effective in increasing the electric resistance and reducing the iron loss. Thus, 0.40% or less of Cu may be included. When the Cu content is more than 0.40%, the improvement effect of reducing the iron loss may be saturated, and surface defects called “copper scab” may be incurred during hot rolling. The lower limit of Cu content is preferably 0.05%, and more preferably 0.10%. The upper limit of Cu content is preferably 0.30%, and more preferably 0.20%.
0% or more and 0.50% or less of P

P (phosphorus) is also the element effective in increasing the electric resistance and reducing the iron loss. Thus, 0.50% or less of P may be included. When the P content is more than 0.50%, the rollability of the silicon steel sheet may deteriorate. The lower limit of P content is preferably 0.005%, and more preferably 0.01%. The upper limit of P content is preferably 0.20%, and more preferably 0.15%.
0% or more and 0.30% or less of Sn
0% or more and 0.30% or less of Sb

Sn (tin) and Sb (antimony) are the elements effective in stabilizing the secondary recrystallization, and thereby, developing the {110}<001> orientation. Thus, 0.30% or less of Sn may be included, and 0.30% or less of Sb may be included. When the Sn content or the Sb content is more than 0.30%, the magnetic characteristics may deteriorate.

The lower limit of Sn content is preferably 0.02%, and more preferably 0.05%. The upper limit of Sn content is preferably 0.15%, and more preferably 0.10%.

The lower limit of Sb content is preferably 0.01%, and more preferably 0.03%. The upper limit of Sb content is preferably 0.15%, and more preferably 0.10%.
0% or more and 1.00% or less of Ni

Ni (nickel) is also the element effective in increasing the electric resistance and reducing the iron loss. Moreover, Ni is an element effective in controlling the metallographic structure of the hot rolled steel sheet, and thereby, improving the magnetic characteristics. Thus, 1.00% or less of Ni may be included. When the Ni content is more than 1.00%, the secondary recrystallization may be unstable. The lower limit of Ni content is preferably 0.01%, and more preferably 0.02%. The upper limit of Ni content is preferably 0.20%, and more preferably 0.10%.
0% or more and 0.008% or less of B

B (boron) is the element effective in acting as the inhibitor as BN. Thus, 0.008% or less of B may be included. When the B content is more than 0.008%, the magnetic characteristics may deteriorate. The lower limit of B content is preferably 0.0005%, and more preferably 0.001%. The upper limit of B content is preferably 0.005%, and more preferably 0.003%.
0% or more and 0.15% or less of V
0% or more and 0.2% or less of Nb
0% or more and 0.015% or less of Ti

V (vanadium), Nb (niobium), and Ti (titanium) are the elements which act as the inhibitor by bonding to N, C, or the like. Thus, 0.15% or less of V may be included, 0.2% or less of Nb may be included, and 0.015% or less of Ti may be included. When the elements remain in the final product (electrical steel sheet) and when the V content is more than 0.15%, when the Nb content is more than 0.2%, or when the Ti content is more than 0.015%, the magnetic characteristics may deteriorate.

The lower limit of V content is preferably 0.002%, and more preferably 0.01%. The upper limit of V content is preferably 0.10%, and more preferably 0.05%.

The lower limit of Nb content is preferably 0.005%, and more preferably 0.02%. The upper limit of Nb content is preferably 0.1%, and more preferably 0.08%.

The lower limit of Ti content is preferably 0.002%, and more preferably 0.004%. The upper limit of Ti content is preferably 0.010%, and more preferably 0.008%.
0% or more and 0.10% or less of Mo

Mo (molybdenum) is also the element effective in increasing the electric resistance and reducing the iron loss. Thus, 0.10% or less of Mo may be included. When the Mo content is more than 0.10%, the rollability of the steel sheet may deteriorate. The lower limit of Mo content is preferably 0.005%, and more preferably 0.01%. The upper limit of Mo content is preferably 0.08%, and more preferably 0.05%.
0% or more and 0.010% or less of Bi

Bi (bismuth) is the element effective in stabilizing precipitates such as sulfide or the like, and thereby, improving the inhibitors functions. Thus, 0.010% or less of Bi may be included. When the Bi content is more than 0.010%, the magnetic characteristics may deteriorate. The lower limit of Bi content is preferably 0.001%, and more preferably 0.002%. The upper limit of Bi content is preferably 0.008%, and more preferably 0.006%.
0% or more and 0.005% or less of Al

Al (aluminum) is the element effective in acting as the inhibitor by bonding to N. Thus, 0.01 to 0.065% of Al may be included before final annealing, for instance, at the stage of slab. However, when Al remains as the impurity in the final product (electrical steel sheet) and when the Al content is more than 0.005%, the magnetic characteristics may deteriorate. Thus, the Al content in the final product is preferably 0.005% or less. The upper limit of Al content in the final product is preferably 0.004%, and more preferably 0.003%. Herein, since Al in the final product is the impurity, the lower limit thereof is not particularly limited and is preferably lower. Since it is not industrially easy to control the Al content in the final product to 0%, the lower limit of Al content in the final product may be more than 0% or 0.0005%. The above Al content indicates the acid-soluble Al content.
0% or more and 0.005% or less of C
0% or more and 0.005% or less of N

C (carbon) is the element effective in controlling the primary recrystallized structure and improving the magnetic characteristics. N (nitrogen) is the element effective in acting as the inhibitor by bonding to Al, B, or the like. Thus, 0.02 to 0.10% of C may be included before decarburization annealing, for instance, at the stage of slab. Also, 0.01 to 0.05% of N may be included before final annealing, for instance, at the stage after nitriding annealing. However, when the elements remain as the impurities in the final product and when the C content and the N content are more than 0.005% respectively, the magnetic characteristics may deteriorate. Thus, the C content and the N content in the final product are preferably 0.005% or less respectively. The C content and the N content in the final product are preferably 0.004% or less respectively, and more preferably 0.003% or less respectively. Moreover, the total amount of C and N in the final product is preferably 0.005% or less. Herein, since C and N in the final product are the impurities, the contents thereof are not particularly limited and are preferably lower. Since it is not industrially easy to control the C content and the N content in the final product to 0% respectively, the C content and the N content in the final product may be more than 0% respectively, or 0.0005% or more respectively.
0% or more and 0.005% or less of S
0% or more and 0.005% or less of Se

S (sulfur) and Se (selenium) are the elements effective in acting as the inhibitor by bonding to Mn or the like. Thus, 0.005 to 0.050% of S and 0 to 0.005% of Se may be included before final annealing, for instance, at the stage of slab. However, when the elements remain as the impurities in the final product and when the S content and the Se content are more than 0.005% respectively, the magnetic characteristics may deteriorate. Thus, the S content and the Se content in the final product are preferably 0.005% or less respectively. The S content and the Se content in the final product are preferably 0.004% or less respectively, and more preferably 0.003% or less respectively. Moreover, the total amount of S and Se in the final product is preferably 0.005% or less. Herein, since S and Se in the final product are the impurities, the contents thereof are not particularly limited and are preferably lower. Since it is not industrially easy to control the S content and the Se content in the final product to 0% respectively, the S content and the Se content in the final product may be more than 0% respectively, or 0.0005% or more respectively.

In the embodiment, the silicon steel sheet may include, as the optional elements, by mass %, at least one element selected from the group consisting of
0.05% or more and 1.00% or less of Mn,
0.02% or more and 0.30% or less of Cr,
0.05% or more and 0.40% or less of Cu,
0.05% or more and 0.50% or less of P,
0.02% or more and 0.30% or less of Sn,
0.01% or more and 0.30% or less of Sb,
0.01% or more and 1.00% or less of Ni,
0.0005% or more and 0.008% or less of B,
0.002% or more and 0.15% or less of V,
0.005% or more and 0.2% or less of Nb,
0.005% or more and 0.10% or less of Mo,
0.002% or more and 0.015% or less of Ti, and
0.001% or more and 0.010% or less of Bi.

The chemical composition of silicon steel may be measured by typical analytical methods. The method for measuring the steel composition is described later in detail.

Next, other features of the silicon steel sheet is described.

In the grain-oriented electrical steel sheet according to the embodiment, it is preferable that the silicon steel sheet has the texture aligned with the {110}<001> orientation. When the silicon steel sheet is controlled to have the Goss orientation, the magnetic characteristics is favorably improved.

Moreover, the thickness of the silicon steel sheet is not particularly limited. In order to reduce the iron loss, the thickness in average is preferably 0.35 mm or less, and more preferably 0.30 mm or less. The lower limit of the thickness of the silicon steel sheet is not particularly limited, but may be 0.10 mm from the viewpoint of manufacturing facilities and costs.

Moreover, it is preferable that the surface roughness of the silicon steel sheet (the roughness of the interface between the intermediate layer and the base steel sheet) is smooth. For instance, as the surface roughness of the silicon steel sheet, the arithmetic average roughness (Ra) is preferably 0.5 μm or less, and more preferably 0.3 μm or less. The lower limit of the arithmetic average roughness (Ra) of the base steel sheet is not particularly limited, but may be 0.1 μm because the improvement effect of reducing the iron loss may be saturated when it is 0.1 μm or less.

In the grain-oriented electrical steel sheet according to the embodiment, due to the above feature, the coating adhesion is excellent even without the forsterite film. Thus, the iron loss characteristics is favorably improved.

Hereinafter, the measuring method of each feature described above of the grain-oriented electrical steel sheet is described in detail.

### Measuring Method of Technical Feature

First, the layering structure described above of the grain-oriented electrical steel sheet may be identified by the following method for instance.

A test piece is cut out from the grain-oriented electrical steel sheet, and the layering structure of the test piece is observed with the scanning electron microscope (SEM) or the transmission electron microscope (TEM). For instance, the layer with the thickness of 300 nm or more may be observed with SEM, and the layer with the thickness of less than 300 nm may be observed with TEM.

Specifically, first, the test piece is cut out so that the cutting direction is parallel to the thickness direction (more specifically, the test piece is cut out so that the cross section is parallel to the thickness direction and perpendicular to the rolling direction), and the cross-sectional structure of this cross section is observed with SEM at a magnification at which each layer is included in the observed visual field. For instance, in observation with the reflection electron composition image (COMP image), it can be inferred how many layers the cross-sectional structure includes. For instance, in the COMP image, the steel sheet can be distinguished as light color, the intermediate layer as dark color, and the insulation coating as intermediate color.

In order to identify each layer in the cross-sectional structure, line analysis is performed along the thickness direction using SEM-EDS, and quantitative analysis of the chemical composition of each layer is performed. For instance, the elements to be quantitatively analyzed are five elements Fe, P, Si, O, and Mg. The analysis device is not particularly limited. For instance, SEM (NB5000 of Hitachi High-Tech Corporation), EDS (XFlash (r) 6|30 of Bruker AXS), and EDS analysis software (ESPRIT1.9 of Bruker AXS) may be used.

From the observation results in the COMP image and the quantitative analysis results by SEM-EDS, the base steel sheet is judged to be the area which is the layer located at the deepest position along the thickness direction, which has the Fe content of 80 atomic % or more and the O content of 30 atomic % or less excluding measurement noise, and which has 300 nm or more of the line segment (thickness) on the scanning line of the line analysis. Moreover, an area excluding the base steel sheet is judged to be the intermediate layer and the insulation coating.

Regarding the area excluding the base steel sheet identified above, from the observation results in the COMP image and the quantitative analysis results by SEM-EDS, the phosphate-based coating is judged to be the area which has the Fe content of less than 80 atomic %, the P content of 5 atomic % or more, the Si content of 5 atomic % or more, and the O content of 30 atomic % or more excluding the measurement noise, and which has 300 nm or more of the line segment (thickness) on the scanning line of the line analysis. Moreover, the phosphate-based coating may include aluminum, magnesium, nickel, manganese, or the like derived from phosphate in addition to the above four elements which are utilized for the judgement of the phosphate-based coating.

In order to judge the area which is the phosphate-based coating, precipitates, inclusions, voids, or the like which are contained in the coating are not considered as judgment target, but the area which satisfies the quantitative analysis as the matrix is judged to be the phosphate-based coating. For instance, when precipitates, inclusions, voids, or the like on the scanning line of the line analysis are confirmed from the COMP image or the line analysis results, this area is not considered for the judgment, and the coating is determined by the quantitative analysis results as the matrix. The precipitates, inclusions, and voids can be distinguished from the matrix by contrast in the COMP image and can be distinguished from the matrix by the quantitative analysis results of constituent elements. When judging the phosphate-based coating, it is preferable that the judgement is performed at the position which does not include precipitates, inclusions, and voids on the scanning line of the line analysis.

In a case where an area excludes the base steel sheet and the phosphate-based coating identified above and the line segment (thickness) on the scanning line of the line analysis corresponding to this area is 300 nm or more, this area is determined as the intermediate layer.

The intermediate layer may satisfy the Fe content of less than 80 atomic %, the P content of less than 5 atomic %, the Si content of 20 atomic % or more, and the O content of 30 atomic % or more. Moreover, when the intermediate layer is not the forsterite film but the oxide film mainly containing silicon oxide, the intermediate layer may satisfy the Mg content of less than 20 atomic %. In addition, the quantitative analysis results of the intermediate layer do not include the analysis results of precipitates, inclusions, voids, or the like contained in the intermediate layer but are the quantitative analysis results as the matrix. When judging the intermediate layer, it is preferable that the judgement is performed at the position which does not include precipitates, inclusions, and voids on the scanning line of the line analysis.

The identification of each layer and the measurement of the thickness by the above-mentioned COMP image observation and SEM-EDS quantitative analysis are performed on five places or more while changing the observed visual field. Regarding the thicknesses of each layer obtained from five places or more in total, an average value is calculated by excluding the maximum value and the minimum value from the values, and this average value is taken as the average thickness of each layer.

In addition, if a layer in which the line segment (thickness) on the scanning line of the line analysis is less than 300 nm is included in at least one of the observed visual fields of five places or more as described above, the layer is observed in detail by TEM, and the identification of the corresponding layer and the measurement of the thickness are performed by TEM.

A test piece including a layer to be observed in detail using TEM is cut out by focused ion beam (FIB) processing so that the cutting direction is parallel to the thickness direction (more specifically, the test piece is cut out so that the cross section is parallel to the thickness direction and perpendicular to the rolling direction), and the cross-sectional structure of this cross section is observed (bright-field image) with scanning-TEM (STEM) at a magnification at which the corresponding layer is included in the observed visual field. In the case where each layer is not included in the observed visual field, the cross-sectional structure is observed in a plurality of continuous visual fields.

In order to identify each layer in the cross-sectional structure, line analysis is performed along the thickness direction using TEM-EDS, and quantitative analysis of the chemical composition of each layer is performed. The elements to be quantitatively analyzed are five elements Fe, P, Si, O, and Mg. The analysis device is not particularly limited. For instance, TEM (JEM-2100F of JEOL), EDS (JED-2300T of JEOL), and EDS analysis software (Analysis Station of JEOL) may be used.

From the observation results of the bright-field image by TEM described above and the quantitative analysis results by TEM-EDS, each layer is identified and the average thickness of each layer is measured. The method for judging each layer using TEM and the method for measuring the average thickness of each layer may be performed according to the method using SEM as described above.

When the thickness of each layer identified by TEM is 5 nm or less, it is preferable to use a TEM having a spherical aberration correction function from the viewpoint of spatial resolution. When the thickness of each layer is 5 nm or less, point analysis is performed, for example, at intervals of 2 nm along the thickness direction, the line segment (thickness) of each layer is measured, and this line segment may be adopted as the thickness of each layer. For example, when TEM having a spherical aberration correction function is used, EDS analysis can be performed with a spatial resolution of about 0.2 nm.

In the grain-oriented electrical steel sheet according to the embodiment, the oxide film is included in contact with the base steel sheet, and the phosphate-based coating is included in contact with the oxide film. Therefore, in a case of identifying each layer according to the above-described criterion, layers other than the base steel sheet, the oxide film, and the phosphate-based coating are not included.

In order to measure the compositions of the phosphate-based coating and the oxide film, the quantitative analysis may be conducted in detail using SEM-EDS or TEM-EDS within each area of the phosphate-based coating and the oxide film identified above. For the above quantitative analysis, the line analysis or the point analysis may be conducted at plural points in the target area. When the quantitative analysis is conducted, the elements to be quantitatively analyzed may be not the five elements Fe, P, Si, O, and Mg but all elements to be quantitatively analyzed. As the compositions of the phosphate-based coating and the oxide film, the average composition may be measured in each area of the phosphate-based coating and the oxide film identified above.

Next, the existence of the first crystalline phosphorus oxide whose crystal structure corresponds to Fe₂P₂O₇ and the second crystalline phosphorous oxide whose crystal structure corresponds to Fe₇(P₂O₇)₄ in the phosphate-based coating identified above may be confirmed by the following method.

Based on the identification results of the phosphate-based coating, the test piece including the phosphate-based coating is cut out by FIB processing so that the cutting direction is parallel to the thickness direction (more specifically, a test piece is cut out so that the cross section is parallel to the thickness direction and perpendicular to the rolling direction), and the cross-sectional structure of this cross section is observed with TEM at a magnification at which the phosphate-based coating is included in the observed visual field.

Wide-area electron beam diffraction is performed on the phosphate-based coating in the observed visual field with an electron beam diameter of smaller of 1/10 of the phosphate-based coating or 200 nm and it is checked whether or not any crystalline phase is included in the electron beam irradiated area by the electron beam diffraction pattern.

In a case where it can be confirmed that a crystalline phase is included by the above-mentioned electron beam diffraction pattern, the crystalline phase as an object is confirmed in a bright-field image, and point analysis is performed on the crystalline phase by TEM-EDS. As a result of point analysis by TEM-EDS, when the chemical composition of the crystalline phase as the object contains Fe, P, and O in a total amount of 70 atomic % or more and 100 atomic % or less and 10 atomic % or less of Si, the crystalline phase can be determined to be crystalline and a phosphorus-containing phase. Therefore, the crystalline phase is determined as the crystalline phosphorous oxide.

As necessary, electron beam diffraction is performed on the crystalline phase as the object with a narrowed electron beam so as to obtain information from only the crystalline phase as the object, and the crystal structure of the crystalline phase as the object is identified from the electron beam diffraction pattern. This identification may be performed using the Powder Diffraction File (PDF) of the International Centre for Diffraction Data (ICDD).

From TEM-EDS point analysis results and the electron beam diffraction results described above, it can be determined whether or not the crystalline phase is the first crystalline phosphorus oxide whose crystal structure corresponds to Fe₂P₂O₇ or the second crystalline phosphorous oxide whose crystal structure corresponds to Fe₇(P₂O₇)₄.

In addition, identification of whether the crystalline phase has Fe₂P₂O₇ structure may be performed based on PDF: No. 01-072-1516. Identification of whether the crystalline phase has Fe₇(P₂O₇)₄ structure may be performed based on PDF: No. 01-079-2259. In a case where the crystalline phase is identified based on the PDF described above, the identification may be performed with an interplanar spacing tolerance of ±5% and an interplanar angle tolerance of ±3°.

Confirmation (wide-area electron beam irradiation) of whether or not any crystalline phase is included in the electron beam irradiated area is performed sequentially along the thickness direction from the interface between the phosphate-based coating and the oxide film toward the outermost surface without a gap, and the confirmation of the electron beam diffraction pattern is repeated until it is confirmed that no crystalline phase is included in the electron beam irradiated area.

By repeating the electron beam irradiation along the thickness direction, whether or not the crystalline phosphorus oxide is included in the phosphate-based coating and the area where the crystalline phosphorus oxide in the phosphate-based coating is included can be identified. For instance, it is possible to identify whether the crystalline phosphorus oxide is included in either the internal region or the surface region of the phosphate-based coating.

The area fraction of the crystalline phosphorous oxide may be obtained as follows. For instance, the first crystalline phosphorus oxide and the second crystalline phosphorous oxide are identified by the above method, the crystalline phosphorus oxide identified above and the matrix are binarized, and then, the area fraction of the crystalline phosphorous oxide may be obtained by image analysis. For instance, the area fraction of the first crystalline phosphorus oxide included in the surface region is percentage obtained by dividing the total area of the first crystalline phosphorus oxide by the total area of the surface region. Regarding image binarization for image analysis, the image binarization may be performed by manually coloring the crystalline phosphorus oxide in the photograph based on the above identification result of the crystalline phosphorus oxide.

Moreover, the crystalline phosphorous oxide is observed as a black precipitate. Thus, the black precipitate and the matrix are binarized, and then, the area fraction of the crystalline phosphorous oxide may be obtained by image analysis. The above area fraction is the total area fraction of the first crystalline phosphorus oxide and the second crystalline phosphorous oxide included in the observed visual field. Thus, the existence ratio (area ratio) between the first crystalline phosphorous oxide and the second crystalline phosphorous oxide may be obtained in advance, and the area fraction of the first crystalline phosphorous oxide and the area fraction of the second crystalline phosphorous oxide may be obtained using the above existence ratio and the above total area fraction.

Moreover, whether or not the second crystalline phosphorous oxide in the phosphate-based coating includes V, W, Zr, Co, or Mo may be confirmed as follows. For instance, the elements included in the second crystalline phosphorous oxide whose crystal structure corresponds to Fe₇(P₂O₇)₄ identified above may be qualitatively analyzed using TEM-EDS. Since the second crystalline phosphorous oxide is thermally unstable as the precipitate, the quantitative analysis is difficult to be conducted. However, by the above qualitative analysis, whether or not the second crystalline phosphorous oxide includes V, W, Zr, Co, or Mo may be confirmed.

Moreover, the equivalent circle diameter of the second crystalline phosphorous oxide may be measured as follows. For instance, the equivalent circle diameters of at least five crystalline phosphorus oxides are obtained by image analysis in each of the observed visual fields of five places or more, an average value is calculated by excluding the maximum value and the minimum value from the obtained equivalent circle diameters, and the average value is adopted as the average equivalent circle diameter of the crystalline phosphorus oxide. Regarding image binarization for image analysis, the image binarization may be performed by manually coloring the crystalline phosphorus oxide in the photograph based on the above identification result of the crystalline phosphorus oxide.

Next, the above steel composition of the silicon steel sheet may be confirmed by the following method for instance.

For instance, the chemical composition may be measured by using ICP-AES (Inductively Coupled Plasma-Atomic Emission Spectrometer: inductively coupled plasma emission spectroscopy spectrometry). In addition, C and S may be measured by the infrared absorption method after combustion, N may be measured by the thermal conductometric method after fusion in a current of inert gas, and O may be measured by, for instance, the non-dispersive infrared absorption method after fusion in a current of inert gas.

In a case where the grain-oriented electrical steel sheet as the measurement specimen has the oxide film, the phosphate-based coating, or the like on the surface thereon, the steel composition may be measured after removing the above coating, layer, or the like.

For instance, the grain-oriented electrical steel sheet with the coating may be immersed in hot alkaline solution. Specifically, it is possible to remove the coating or the like (the oxide film, the phosphate-based coating, or the like) on the silicon steel sheet by immersing the steel sheet in sodium hydroxide aqueous solution which includes 20 mass % of NaOH and 80 mass % of H₂O at 80° C. for 20 minutes, washing it with water, and then, drying it. Moreover, the immersing time in sodium hydroxide aqueous solution may be adjusted depending on the thickness of the coating or the like on the silicon steel sheet.

The texture of the silicon steel sheet may be measured by typical analytical methods. For instance, the texture may be measured by the X-ray diffraction method (Laue method). The Laue method is the method such that X-ray beam is perpendicularly irradiated the steel sheet with and that the diffraction spots which are transmitted or reflected are analyzed. By analyzing the diffraction spots, it is possible to identify the crystal orientation at the point irradiated with X-ray beam. Moreover, by changing the irradiated point and by analyzing the diffraction spots in plural points, it is possible to obtain the distribution of the crystal orientation based on each irradiated point. The Laue method is the preferred method for identifying the crystal orientation of the metallographic structure in which the grains are coarse.

The surface roughness of the silicon steel sheet (the roughness of the interface between the intermediate layer and the base steel sheet) may be measured using stylus type surface roughness tester or non-contact laser surface roughness tester. In a case where the silicon steel sheet has the oxide film, the phosphate-based coating, or the like on the surface thereon, the surface roughness may be measured after removing the above coating, layer, or the like.

Next, the method for manufacturing the grain-oriented electrical steel sheet according to the embodiment is described.

### Manufacturing Method

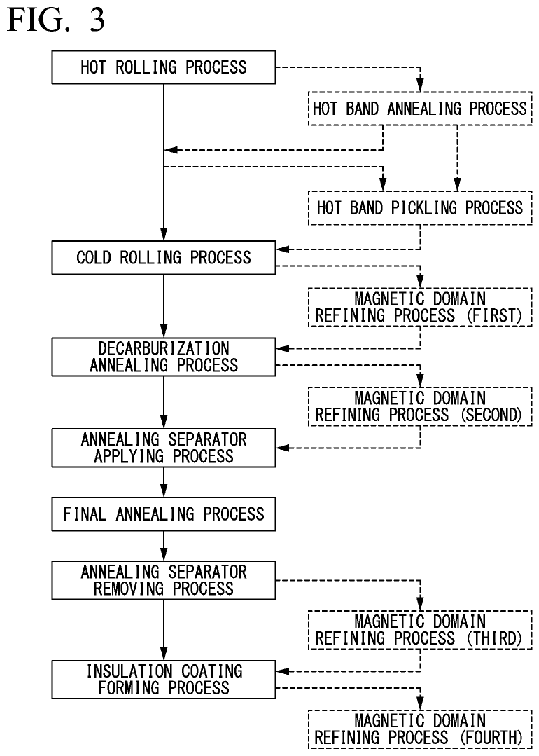

FIG. 3 is the flow chart illustrating the method for manufacturing the grain-oriented electrical steel sheet according to the embodiment of the present invention. In the FIG. 3, the processes surrounded by the solid line indicate the essential processes, and the processes surrounded by the broken line indicate the optional processes.

The method for manufacturing the grain-oriented electrical steel sheet according to the embodiment is not limited to the following method. The following manufacturing method is an instance for manufacturing the oriented electrical steel sheet according to the embodiment.

The method for manufacturing the grain-oriented electrical steel sheet according to the embodiment is the method for manufacturing the grain-oriented electrical steel sheet without the forsterite film and includes the following processes.
(i) Hot rolling process of hot-rolling a steel piece including predetermined chemical composition to obtain a hot rolled steel sheet.
(ii) Cold rolling process of cold-rolling the hot rolled steel sheet by cold-rolling once or by cold-rolling plural times with an intermediate annealing to obtain a cold rolled
(iii) Decarburization annealing process of decarburization-annealing the cold rolled steel sheet to obtain a decarburization annealed sheet.
(iv) Annealing separator applying process of applying and drying an annealing separator including Al₂O₃ and MgO to the decarburization annealed sheet.
(v) Final annealing process of final-annealing the decarburization annealed sheet after applying the annealing separator to obtain a final annealed sheet.
(vi) Annealing separator removing process of removing a redundant annealing separator from a surface of the final annealed sheet by methods including one or both of water-washing and pickling.
(vii) Insulation coating forming process of forming an insulation coating on the surface of the final annealed sheet.

In addition, the method for manufacturing the grain-oriented electrical steel sheet according to the embodiment may further include the following processes.
(a) Hot band annealing process of annealing the hot rolled steel sheet.
(b) Hot band pickling process of pickling the hot rolled steel sheet.
(c) Magnetic domain refining process of conducting a magnetic domain refining treatment.

Hereinafter, each process is described in detail.

### Hot Rolling Process

In the hot rolling process, the steel piece is hot-rolled to obtain the hot rolled steel sheet, the steel piece including, as the chemical composition, by mass %,
0.020% or more and 0.10% or less of C,
0.80% or more and 7.0% or less of Si,
0.05% or more and 1.0% or less of Mn,
0% or more and 0.050% or less in total content of S and Se,
0.010% or more and 0.065% or less of acid soluble Al,
0.004% or more and 0.012% or less of N,
0% or more and 0.30% or less of Cr,
0% or more and 0.40% or less of Cu,
0% or more and 0.50% or less of P,
0% or more and 0.30% or less of Sn,
0% or more and 0.30% or less of Sb,
0% or more and 1.0% or less of Ni,
0% or more and 0.008% or less of B,
0% or more and 0.15% or less of V,
0% or more and 0.20% or less of Nb,
0% or more and 0.10% or less of Mo,
0% or more and 0.015% or less of Ti,
0% or more and 0.010% or less of Bi, and
a balance consisting of Fe and impurities. In the embodiment, the steel sheet after the hot rolling process is referred to as the hot rolled steel sheet.

The method for making the steel piece (slab) to be used in the hot rolling process is not limited. For instance, molten steel with predetermined chemical composition may be made, and the slab may be made by using the molten steel. The slab may be made by continuous casting. An ingot may be made by using the molten steel, and then, the slab may be made by blooming the ingot. Moreover, the slab may be made by other methods.

A thickness of the slab is not particularly limited. The thickness of the slab may be 150 to 350 mm for instance. The thickness of the slab is preferably 220 to 280 mm. The slab with the thickness of 10 to 70 mm which is a so-called thin slab may be used.

Limitation reasons of the chemical composition of the steel piece are explained. Hereinafter, “%” of the chemical composition represents “mass %”.
0.020% or more and 0.10% or less of C

C (carbon) is an element effective in controlling the primary recrystallized structure, but negatively affects the magnetic characteristics. Thus, C is the element to be removed by decarburization annealing before final annealing. When the C content is more than 0.10%, a time for decarburization annealing needs to be prolonged, and the productivity decreases. Thus, the C content is to be 0.10% or less. The C content is preferably 0.085% or less, and more preferably 0.070% or less.

It is favorable that the C content is lower. However, when considering the productivity in industrial manufacture and the magnetic characteristics of the product, the lower limit of the C content is substantially 0.020%.
0.80% or more and 7.0% or less of Si

Si (silicon) increases the electric resistance of grain-oriented electrical steel sheet, and thereby, reduces the iron loss. When the Si content is less than 0.80%, Y transformation occurs during the final annealing and the crystal orientation of grain-oriented electrical steel sheet is impaired. Thus, the Si content is to be 0.80% or more. The Si content is preferably 2.0% or more, and more preferably 2.50% or more.

On the other hand, when the Si content is more than 7.0%, the cold workability deteriorates and the cracks tend to occur during cold rolling. Thus, the Si content is to be 7.0% or less. The Si content is preferably 5.0% or less, and more preferably 3.5% or less.
0.05% or more and 1.0% or less of Mn

Mn (manganese) increases the electric resistance of grain-oriented electrical steel sheet, and thereby, reduces the iron loss. Moreover, Mn forms MnS and/or MnSe which act as the inhibitor by bonding to S and/or Se. When the Mn content is within the range of 0.05% or more and 1.0% or less, the secondary recrystallization becomes stable. Thus, the Mn content is to be 0.05% or more and 1.0% or less. The lower limit of the Mn content is preferably 0.08%, and more preferably 0.09%. The upper limit of the Mn content is preferably 0.50%, and more preferably 0.20%.
0% or more and 0.050% or less in total content of one or both of S and Se

S (sulfur) and Se (selenium) are elements to form MnS or MnSe which act as the inhibitor by bonding to Mn.

When the total amount of one or both of S and Se (S+Se) is more than 0.050%, the dispersion state of precipitation of MnS and/or MnSe becomes uneven. In the case, the desired secondary recrystallized structure cannot be obtained, and the magnetic flux density may decrease. Moreover, MnS remains in the steel after purification annealing, and the hysteresis loss may increase. Thus, the total amount of S and Se is to be 0.050% or less.

The lower limit of the total amount of S and Se is not particularly limited, and may be 0%. The lower limit thereof may be 0.003%, and may be 0.005%. When the inhibitor thereof is used, the lower limit is preferably 0.015%.
0.010% or more and 0.065% or less of acid soluble Al (Sol. Al)

The acid soluble Al (aluminum) is an element to form AlN and/or (Al, Si)N which acts as the inhibitor by bonding to N. When the amount of acid soluble Al is less than 0.010%, the effect of addition is not sufficiently obtained, and the secondary recrystallization does not proceed sufficiently. Thus, the amount of acid soluble Al is to be 0.010% or more. The amount of acid soluble Al is preferably 0.015% or more, and more preferably 0.020% or more.

On the other hand, when the amount of acid soluble Al is more than 0.065%, the dispersion state of precipitation of AlN and/or (Al, Si)N becomes uneven, the desired secondary recrystallized structure cannot be obtained, and the magnetic flux density decreases. Thus, the amount of acid soluble Al (Sol. Al) is to be 0.065% or less. The amount of acid soluble Al is preferably 0.055% or less, and more preferably 0.050% or less.
0.004% or more and 0.012% or less of N

N (nitrogen) is an element to form AlN and/or (Al, Si)N which act as the inhibitor by bonding to Al. When the N content is less than 0.004%, the formation of AlN and/or (Al, Si)N becomes insufficient. Thus, the N content is to be 0.004% or more. The N content is preferably 0.006% or more, and more preferably 0.007% or more.

On the other hand, when the N content is more than 0.012%, the blisters (voids) may be formed in the steel sheet. Thus, the N content is to be 0.012% or less.

The steel piece includes, as the chemical composition, the above elements, and the balance consists of Fe and impurities. However, in consideration of the influence on the magnetic characteristics and the improvement of the inhibitors functions by forming compounds, the steel piece may include at least one of optional elements as substitution for a part of Fe. For instance, the optional elements included as substitution for a part of Fe may be Cr, Cu, P, Sn, Sb, Ni, B, V, Nb, Mo, Ti, and Bi. However, the optional elements do not need to be included, the lower limits thereof may be 0% respectively. Moreover, even if the optional elements may be included as impurities, the above-mentioned effects are not affected. Herein, the impurities correspond to elements which are contaminated during industrial manufacture of steel from ores and scrap that are used as a raw material of steel, or from environment of a manufacturing process.
0% or more and 0.30% or less of Cr
0% or more and 0.40% or less of Cu
0% or more and 0.50% or less of P
0% or more and 0.30% or less of Sn
0% or more and 0.30% or less of Sb
0% or more and 1.00% or less of Ni
0% or more and 0.008% or less of B
0% or more and 0.15% or less of V
0% or more and 0.2% or less of Nb
0% or more and 0.10% or less of Mo
0% or more and 0.015% or less of Ti
0% or more and 0.010% or less of Bi

The optional elements may be included as necessary. Thus, a lower limit of the respective optional elements does not need to be limited, and the lower limit may be 0%.

Next, conditions for hot-rolling the above steel piece are explained.

The conditions of the hot rolling are not particularly limited. For instance, the conditions are as follows.

The slab is heated before the hot rolling. The slab is put and heated in a known heating furnace or a known soaking furnace. As one method, the slab is heated to 1280° C. or less. By setting the heating temperature of the slab to 1280° C. or less, for instance, it is possible to avoid various problems when the heating temperature is more than 1280° C. (a dedicated high temperature heating furnace is required, the molten scale amount rapidly increases, and the like). The lower limit of the heating temperature of the slab is not particularly limited. However, when the heating temperature is excessively low, the hot rolling may become difficult and the productivity may be decreased. Thus, the heating temperature may be set in the range of 1280° C. or less in consideration of the productivity. The lower limit of the heating temperature of the slab is preferably 1100° C. The upper limit of the heating temperature of the slab is preferably 1250° C.

In addition, as another method, the slab is heated to higher temperature of 1320° C. or more. It is possible to stabilize the secondary recrystallization by heating the slab to higher temperature of 1320° C. or more and dissolving AlN and Mn(S, Se) and by finely precipitating them in the subsequent processes.

The slab heating in itself may be omitted, and the hot rolling may be conducted after casting and before decreasing the temperature of the slab.

The heated slab is hot-rolled by a hot rolling mill, and thereby, the hot rolled steel sheet is obtained. The hot rolling mill includes, for instance, a rough rolling mill and a final rolling mill which is arranged downstream of the rough rolling mill. The rough rolling mill includes rough rolling stands which are in a row. Each of the rough rolling stands has plural rolls arranged one above the other. In the same way, the final rolling mill includes final rolling stands which are in a row. Each of the final rolling stands has plural rolls arranged one above the other. The heated steel piece is rolled by the rough rolling mill and then by the final rolling mill, and thereby, the hot rolled steel sheet is obtained.

A final temperature in the hot rolling process (the temperature of the steel sheet at outlet side of the final rolling stand by which the steel sheet is finally rolled in the final rolling mill) may be 700 to 1150° C. The hot rolled steel sheet is produced by the hot rolling process explained above.

### Hot Band Annealing Process

In the hot band annealing process, as necessary, the hot rolled steel sheet obtained by the hot rolling process is annealed (hot band annealed) to obtain the hot band annealed sheet. In the embodiment, the steel sheet after the hot band annealing process is referred to as the hot band annealed sheet.

The hot band annealing is conducted in order to homogenize the nonuniform structure after hot rolling, to control the precipitation of AlN which is the inhibitor (precipitate finely), and to control second phase, solute carbon, and the like. As the annealing conditions, known conditions may be applied according to the purpose. For instance, in order to homogenize the nonuniform structure after hot rolling, the hot rolled steel sheet is held at 750 to 1200° ° C. of the heating temperature (furnace temperature in a hot band annealing furnace) for 30 to 600 seconds.

The hot band annealing is not always necessary. The hot band annealing may be conducted as a result of considering the characteristics and the manufacturing cost required for the grain-oriented electrical steel sheet finally produced.

### Hot Band Pickling Process

In the hot band pickling process, as necessary, the hot rolled steel sheet after the hot rolling process or the hot band annealed sheet after the hot band annealing process in a case where the hot band annealing has been conducted is pickled in order to remove surface scale. The pickling conditions are not particularly limited, and known conditions may be appropriately applied.

### Cold Rolling Process

In the cold rolling process, the hot rolled steel sheet or the hot band annealed sheet after the hot rolling process, the hot band annealing process, or the hot band pickling process is cold-rolled by once or by plural times with an intermediate annealing to obtain the cold rolled steel sheet. In the embodiment, the steel sheet after the cold rolling process is referred to as the cold rolled steel sheet.

A cold rolling reduction rate in final cold rolling (cumulative cold rolling reduction rate without intermediate annealing or cumulative cold rolling reduction rate after intermediate annealing) is preferably 80% or more, and more preferably 90% or more. The upper limit of the final cold rolling reduction rate is preferably 95%.

Herein, the final cold rolling reduction rate (%) is defined as follows.

Final cold rolling reduction rate (%)=(1−Sheet thickness of steel sheet after final cold rolling/Sheet thickness of steel sheet before final cold rolling)×100

### Decarburization Annealing Process

In the decarburization annealing process, the cold rolled steel sheet after the cold rolling process is subjected to the magnetic domain refining treatment as necessary, and then, is decarburization-annealed to promote the primary recrystallization. Moreover, in the decarburization annealing, C which negatively affects the magnetic characteristics is removed from the steel sheet. In the embodiment, the steel sheet after the decarburization annealing process is referred to as the decarburization annealed sheet.

For the above purposes, in the decarburization annealing, the oxidation degree (PH₂O/PH₂) of annealing atmosphere (furnace atmosphere) is to be 0.01 to 0.15, an annealing temperature is to be 750 to 900° C., and a holding is to be 10 to 600 seconds. The oxidation degree PH₂O/PH₂ is defined as the ratio of water vapor partial pressure PH₂O (atm) to hydrogen partial pressure PH₂ (atm) in the atmosphere.

When the oxidation degree (PH₂O/PH₂) is less than 0.01, the decarburization speed slows down, and thereby, the productivity decreases. In addition, the decarburization does not occur properly, and thereby, the magnetic characteristics after the final annealing deteriorate. On the other hand, when the oxidation degree is more than 0.15, Fe-based oxides are formed, and thereby, it is difficult to smoothen an interface after the final annealing.

When the annealing temperature is less than 750° ° C., the decarburization speed slows down, and thereby, the productivity decreases. In addition, the decarburization does not occur properly, and thereby, the magnetic characteristics after the final annealing deteriorate. On the other hand, when the annealing temperature is more than 900° C., the grain size after the primary recrystallization exceeds favorable size, and thereby, the magnetic characteristics after the final annealing deteriorate.

When the holding time is less than 10 seconds, the decarburization does not occur sufficiently. On the other hand, when the holding time is more than 600 seconds, the productivity decreases. In addition, the grain size after the primary recrystallization exceeds favorable size, and thereby, the magnetic characteristics after the final annealing deteriorate.

Depending on the above oxidation degree (PH₂O/PH₂), a heating rate in a heating stage to the annealing temperature may be controlled. For instance, in a case where the heating including an induction heating is conducted, an average heating rate may be 5 to 1000° C./second. Moreover, in a case where the heating including an electric heating is conducted, an average heating rate may be 5 to 3000° C./second.

In addition, in the decarburization annealing process, the nitriding treatment may be conducted. In the nitriding treatment, the cold rolled steel sheet may be annealed in the atmosphere including ammonia in at least one stage before, during, or after the above holding. In a case where the temperature for heating the slab is lower, it is preferable that the nitriding treatment is conducted in the decarburization annealing process. By additionally conducting the nitriding treatment in the decarburization annealing process, the inhibitor such as AlN and (Al, Si)N is formed prior to the secondary recrystallization in the final annealing process, and thus, it is possible to make the secondary recrystallization occur stably.

Although the conditions for the nitriding treatment are not particularly limited, it is preferable to conduct the nitriding treatment so that the nitrogen content increases by 0.003% or more, preferably 0.005% or more, and more preferably 0.007% or more. When the nitrogen (N) content is more than 0.030%, the effects are saturated. Thus, the nitriding treatment may be conducted so that the nitrogen content becomes 0.030% or less.

The conditions for the nitriding treatment are not particularly limited, and known conditions may be appropriately applied.

For instance, in a case where the nitriding treatment is conducted after decarburization annealing such as the holding at 750 to 900° C. for 10 to 600 seconds in the oxidation degree (PH₂O/PH₂) of 0.01 to 0.15, the nitriding treatment may be conducted such that the cold rolled steel sheet is not cooled to the room temperature but held in the cooling stage in the atmosphere including the ammonia. It is preferable that the oxidation degree (PH₂O/PH₂) in the cooling stage is within the range of 0.0001 to 0.01. Moreover, in a case where the nitriding treatment is conducted during decarburization annealing such as the holding at 750 to 900° ° C. for 10 to 600 seconds in the oxidation degree (PH₂O/PH₂) of 0.01 to 0.15, the ammonia may be included in the atmospheric gas with the above oxidation degree.

### Annealing Separator Applying Process

In the annealing separator applying process, the decarburization annealed sheet after the decarburization annealing process (or the decarburization annealed sheet after the nitriding treatment) is subjected to the magnetic domain refining treatment as necessary, and then, the annealing separator including Al₂O₃ and MgO is applied to the decarburization annealed sheet. Thereafter, the applied annealing separator is dried.

In a case where the annealing separator includes MgO but does not include Al₂O₃, the forsterite film is formed on the steel sheet in the final annealing process. On the other hand, in a case where the annealing separator includes Al₂O₃ but does not include MgO, mullite (3Al₂O₃·2SiO₂) is formed on the steel sheet. The mullite becomes the obstacle of movement of the magnetic domain wall, and thus, causes the deterioration of the magnetic characteristics of the grain-oriented electrical steel sheet.

Thus, in the method for manufacturing the grain-oriented electrical steel sheet according to the embodiment, as the annealing separator, the annealing separator mainly including Al₂O₃ and MgO is utilized. By utilizing the annealing separator mainly including Al₂O₃ and MgO, the forsterite film is not formed on the surface of the steel sheet, and it is possible to smoothen the surface of the steel sheet after the final annealing. Herein, the feature such that Al₂O₃ and MgO is mainly included indicates that the total amount of Al₂O₃ and MgO in the annealing separator is 50 mass % or more.

For the annealing separator, MgO/(MgO+Al₂O₃) which is the mass ratio of MgO and Al₂O₃ is to be 5 to 50%, and the hydrated water is to be 1.5 mass % or less.

When MgO/(MgO+Al₂O₃) is less than 5%, the mullite is excessively formed, and thus, the iron loss deteriorates. On the other hand, when MgO/(MgO+Al₂O₃) is more than 50%, the forsterite is formed, and thus, the iron loss deteriorates.

When the hydrated water in the annealing separator is more than 1.5 mass %, the secondary recrystallization may be unstable, and it may be difficult to smoothen the surface of the steel sheet because the surface of the steel sheet is oxidized (SiO₂ is formed) in the final annealing. The lower limit of the hydrated water is not particularly limited, but may be 0.1 mass % for instance.

The annealing separator is applied by water slurry or by electrostatic spray. In the annealing separator applying process, the annealing separator may further include nitrides such as manganese nitride, iron nitride, and chromium nitride which are decomposed before the secondary recrystallization in the final annealing process and which nitride the decarburization annealed sheet or the decarburized and nitrided sheet.

### Final Annealing Process

The decarburization annealed sheet after applying the above annealing separator is final-annealed to obtain the final annealed sheet. By conducting the final annealing for the decarburization annealed sheet after applying the above annealing separator, the secondary recrystallization proceeds, and the crystal orientation aligns in the {110}<001> orientation. In the embodiment, the steel sheet after the final annealing process is referred to as the final annealed sheet.

In the final annealing, in a case where the atmosphere (furnace atmosphere) includes hydrogen, the oxidation degree (PH₂O/PH₂) is to be 0.00010 to 0.2. In a case where the atmosphere consists of the inert gas (nitrogen, argon, and the like) without the hydrogen, the dew point is to be 0° C. or less.

By controlling the oxidation degree or the dew point to be within the above range depending on the atmosphere, it is possible to stably proceed the secondary recrystallization and to increase the alignment degree of the orientation.

When the oxidation degree is less than 0.00010 in a case where the atmosphere includes the hydrogen, the dense surface silica film formed by the decarburization annealing is reduced before the secondary recrystallization in the final annealing, and thereby, the secondary recrystallization becomes unstable. On the other hand, when the oxidation degree is more than 0.2, the dissolution of the inhibitor such as AlN and (Al, Si)N is promoted, and thereby, the secondary recrystallization becomes unstable. Moreover, when the dew point is more than 0° C. in a case where the atmosphere consists of the inert gas without the hydrogen, the dissolution of the inhibitor such as AlN and (Al, Si)N is promoted, and thereby, the secondary recrystallization becomes unstable. The lower limit of the dew point is not particularly limited, but may be −30° C. for instance.

### Annealing Separator Removing Process

In the annealing separator removing process, the redundant annealing separator is removed from the surface of the steel sheet after the final annealing (the final annealed sheet) by methods including one or both of water-washing and pickling. Here, the redundant annealing separator indicates, for instance, the unreacted annealing separator which has not reacted with the steel sheet during the final annealing.

When the redundant annealing separator is not sufficiently removed from the surface of the steel sheet, the space factor decreases, and the performance as the iron core deteriorates.

In order to remove the redundant annealing separator, a scrubber may be utilized for removing in addition to the water-washing and the pickling. By utilizing the scrubber, it is possible to reliably remove the redundant annealing separator which deteriorates the wettability in the insulation coating forming process.

Moreover, in a case where the pickling is conducted in order to remove the redundant annealing separator, the pickling may be conducted using the acidic solution whose volume concentration is less than 20%. For instance, it is preferable to utilize the solution including less than 20 volume % in total of at least one or two or more of sulfuric acid, nitric acid, hydrochloric acid, phosphoric acid, chloric acid, chromium oxide in aqueous solution, chromium sulfate, permanganic acid, peroxosulfuric acid, and peroxophosphoric acid. It is more preferable to utilize the solution including less than 10 volume % thereof. The lower limit of the volume concentration is not particularly limited, but may be 0.1 volume % for instance. By utilizing the above solution, it is possible to efficiently remove the redundant annealing separator from the surface of the steel sheet. Herein, the above volume % may be the concentration based on the volume at room temperature.

Moreover, in a case where the pickling is conducted, the temperature of the solution is preferably 20 to 80° C. By controlling the temperature of the solution to be within the above range, it is possible to efficiently remove the redundant annealing separator from the surface of the steel sheet.

### Insulation Coating Forming Process

In the insulation coating forming process, the final annealed sheet after the annealing separator removing process is subjected to the magnetic domain refining treatment as necessary, and then, the insulation coating is formed on the surface of the final annealed sheet. In the embodiment, the steel sheet after the insulation coating forming process is referred to as the grain-oriented electrical steel sheet.

The coating applies the tension to the grain-oriented electrical steel sheet, and thereby, reduces the iron loss as the single steel sheet. Moreover, the coating ensures interlaminar electrical insulation when the grain-oriented electrical steel sheets are utilized after being laminated, and thereby, reduces the iron loss as an iron core.

The insulation coating is formed on the surface of the final annealed sheet by applying the insulation coating forming solution which mainly includes at least one of the phosphate or the colloidal silica but not including chromate, by baking at 350 to 600° ° C., and then by heat-treating at 800 to 1000° C.

Moreover, the above insulation coating forming solution does not include the chromate, but includes:
the first metal phosphate which is the metal phosphate of at least one metal selected from Al, Fe, Mg, Mn, Ni, and Zn in 100 parts by mass in solid equivalent;
the second metal phosphate which is the metal phosphate of at least one metal selected from Co, Mo, V, W, and Zr in 3 to 20 parts by mass in solid equivalent;
the colloidal silica in 35 to 125 parts by mass in solid equivalent; and
the polymerization adjuvant in 0.3 to 6.0 parts by mass.

Moreover, the average primary particle size of the above colloidal silica is preferably 7 to 30 nm.

Moreover, the above polymerization adjuvant is preferably at least one selected from the group consisting of nitrous acid, sodium nitrite, potassium nitrite, nitric acid, sodium nitrate, potassium nitrate, chlorous acid, sodium chlorite, phosphonic acid, sodium phosphonate, triphosphoric acid, sodium triphosphate, polyphosphoric acid, and sodium polyphosphate.

Moreover, the above insulation coating forming solution further includes preferably at least one selected from the group consisting of boric acid, sodium borate, titanium oxide, molybdenum oxide, pigments, and barium titanate.

When the baking temperature for the insulation coating is less than 350° C., the solution for the insulation coating drips during passing the steel sheet, poor appearance is caused, and the insulation coating with sufficient adhesion is not obtained. When the baking temperature for the insulation coating is more than 600° ° C., since the heating rate is excessively fast, only the outermost surface of the insulation coating is solidified, and the solidification of the inside is delayed, the formation of the coating becomes improper and the coating adhesion becomes insufficient. When the temperature of the heat treatment after baking is less than 800° C., the formation of the coating becomes improper (insufficient solidification), and the coating tension becomes insufficient. When the temperature of the heat treatment after baking is more than 1000° C., the phosphate is decomposed, the formation of the coating becomes improper, and the coating adhesion becomes insufficient.

The atmospheric gas during the heat treatment of the insulation coating is to be the mixed gas containing 5 to 100 volume % of hydrogen and 95 to 0 volume % of nitrogen, and the oxidation degree (PH₂O/PH₂) of atmosphere is to be 0.001 to 0.15. The holding time at 800 to 1000° ° C. during the heat treatment is to be 10 to 120 seconds.

After the heat treatment under the above conditions, the steel sheet is cooled. The atmospheric gas during cooling after the heat treatment is to be the mixed gas containing 5 to 100 volume % of hydrogen and 95 to 0 volume % of nitrogen, and the oxidation degree (PH₂O/PH₂) of atmosphere is to be 0.001 to 0.1. The average cooling rate in the temperature range of 800 to 500° ° C. during cooling after the heat treatment is to be 5 to 45° C./second.

Moreover, the oxidation degree of atmosphere during cooling after the heat treatment of the insulation coating is changed to smaller value than the oxidation degree of atmosphere during the heat treatment of the insulation coating. However, when the total amount of V, W, Zr, Co, and Mo in the phosphate-based coating satisfies 0.1 atomic % or more and 10 atomic % or less, the oxidation degree of atmosphere during cooling after the heat treatment of the insulation coating does not need to be changed to smaller value than the oxidation degree of atmosphere during the heat treatment of the insulation coating.

The atmosphere gas and the oxidation degree during the heat treatment of the insulation coating, the atmosphere gas, the oxidation degree, and the cooling rate during the cooling after the heat treatment, and changing the oxidation degree of atmosphere in between the heat treatment and the cooling, described above, correspond to the above condition (III). In order to form the first crystalline phosphorus oxide and the second crystalline phosphorous oxide in the phosphate-based coating, it is necessary to satisfy the condition (III).

### Magnetic Domain Refining Process

The method for manufacturing the grain-oriented electrical steel sheet according to the embodiment may include the magnetic domain refining process of conducting the magnetic domain refining treatment at appropriate timing of (first) between the cold rolling process and the decarburization annealing process, (second) between the decarburization annealing process and the annealing separator applying process, (third) between the annealing separator removing process and the insulation coating forming process, or (fourth) after the insulation coating forming process.

By conducting the magnetic domain refining treatment, it is possible to reduce the iron loss of the grain-oriented electrical steel sheet. In a case where the magnetic domain refining treatment is conducted between the cold rolling process and the decarburization annealing process, between the decarburization annealing process and the annealing separator applying process, or between the annealing separator removing process and the insulation coating forming process, the groove may be formed lineally or punctiformly so as to extend in the direction intersecting the rolling direction and so as to have the predetermined interval in the rolling direction. By forming the above groove, the width of 180° domain may be narrowed (180° domain may be refined).

In a case where the magnetic domain refining treatment is conducted after the insulation coating forming process, the stress-strain or the groove may be applied or formed lineally or punctiformly so as to extend in the direction intersecting the rolling direction and so as to have the predetermined interval in the rolling direction. By applying the above stress-strain or forming the above groove, the width of 180° domain may be narrowed (180° domain may be refined).

The above stress-strain may be applied by irradiating laser beam, electron beam, and the like. The above groove may be formed by a mechanical groove forming method such as toothed gear, by a chemical groove forming method such as electrolytic etching, by a thermal groove forming method such as laser irradiation, and the like. In a case where the insulation coating is damaged and the performance such as electrical insulation deteriorates by applying the above stress-strain or forming the above groove, the insulation coating may be formed again, and thereby, the damage may be repaired.

### EXAMPLES

The effects of an aspect of the present invention are described in detail with reference to the following examples. However, the condition in the examples is an example condition employed to confirm the operability and the effects of the present invention, so that the present invention is not limited to the example condition. The present invention can employ various types of conditions as long as the conditions do not depart from the scope of the present invention and can achieve the object of the present invention.

The steel slab whose chemical composition was controlled to be the composition shown in Table 1 as the chemical composition of the silicon steel sheet was heated to 1150° C. and then hot-rolled to obtain the hot rolled steel sheet having the thickness of 2.6 mm. After subjecting the hot rolled steel sheet to the hot band annealing as necessary, the hot rolled steel sheet was cold-rolled once or cold-rolled plural times with the intermediate annealing to obtain the cold rolled steel sheet having the final thickness of 0.22 mm. The cold rolled steel sheet was decarburization-annealed and then subjected to the nitriding treatment held in the atmosphere containing the ammonia during cooling. The known conditions were applied from the slab heating to the nitriding treatment.

For the decarburization annealed sheet after the above decarburization annealing, the annealing separator was applied and dried. The conditions of the ratio of MgO and Al₂O₃(MgO/(MgO+Al₂O₃)) and the hydrated water are shown in Tables 2 to 5. Herein, the total amount of Al₂O₃ and MgO in the annealing separator was 50 mass % or more. The decarburization annealed sheet after applying the annealing separator was final-annealed at 1200° ° C. for 20 hours.

Thereafter, the insulation coating forming solution whose composition was controlled was applied, baked, and heat-treated under conditions shown in Tables 2 to 5. After the heat treatment, the cooling under conditions shown in Tables 2 to 5 was conducted, and thereby, the insulation coating was formed.

Moreover, the magnetic domain refining treatment was conducted after the insulation coating forming process. For the magnetic domain refinement, the stress-strain was applied or the groove was formed by laser.

For the obtained grain-oriented electrical steel sheets Nos. 1 to 73, the chemical composition of silicon steel sheet, the average layer composition and the average thickness of intermediate layer, the average layer composition and the average thickness of insulation coating, and the state of crystalline phosphorous oxide in insulation coating were evaluated on the basis of the above method. These results are shown in Tables 1 to 17. In the tables, “first region” indicates “first internal region” and “second region” indicates “second internal region”.

Moreover, for the obtained grain-oriented electrical steel sheets Nos. 1 to 73, the iron loss and the coating adhesion were evaluated.

### Iron Loss

The samples were taken from the obtained grain-oriented electrical steel sheet, and the iron loss W17/50 (W/kg) was measured under the conditions of 50 Hz of AC frequency and 1.7 T of excited magnetic flux density on the basis of the epstein test regulated by JIS C2550-1: 2000. When the iron loss W17/50 was less than 0.68 W/kg, it was judged to as acceptable.

### Coating Adhesion

The samples were taken from the obtained grain-oriented electrical steel sheets, and the coating adhesion of the insulation coating was evaluated by rolling the sample around the cylinder with 20 mm of diameter or 15 mm of diameter (180° bending) and by measuring the area fraction of remained coating after bending back. In the evaluation of the coating adhesion of the insulation coating, the presence or absence of delamination of the insulation coating was visually evaluated. When the area fraction of remained coating which was not delaminated from the steel sheet was 90% or more, it was regarded as “Very Good”. When the area fraction was 86% or more and less than 90%, it was regarded as “Good”. When the area fraction was 80% or more and less than 86%, it was regarded as “Poor”. When the area fraction was less than 80%, it was regarded as “NG”. When the area fraction of remained coating was 86% or more (the above “Very Good” and “Good”), it was judged to as acceptable in both test conditions of with 20 mm of diameter or 15 mm of diameter.

These results are shown in Tables 18 to 21.

As shown in Tables 1 to 21, in the inventive examples among the examples Nos. 1 to 73, the product features satisfied the range of the present invention, and thus, the coating adhesion was excellent. Moreover, the iron loss was excellent.

On the other hand, in the comparative examples among the examples Nos. 1 to 73, at least one of the product features did not satisfy the range of the present invention, the iron loss and/or the coating adhesion was inferior.

TABLE 1

| | MANUFACTURING RESULTS | | | | | | | | | | | | | | | | | | |
|---|---|---|---|---|---|---|---|---|---|---|---|---|---|---|---|---|---|---|---|
| | CHEMICAL COMPOSITION OF SILICON STEEL SHEET (IN UNITS OF MASS %, | | | | | | | | | | | | | | | | | | |
| | BALANCE CONSISTING OF Fe AND IMPURITIES) | | | | | | | | | | | | | | | | | | |
| | Si | Mn | Cr | Cu | P | Sn | Sb | Ni | B | V | Nb | Mo | Ti | Bi | Al | C | N | S | Se |
| STEEL A | 3.3 | 0.1 | 0.1 | — | 0.03 | 0.05 | — | — | — | — | — | — | — | — | 0.001 | 0.001 | 0.001 | 0.001 | — |
| STEEL B | 2.7 | 0.2 | — | — | — | — | — | — | — | — | — | — | — | — | 0.001 | 0.001 | 0.001 | 0.001 | — |
| STEEL C | 3.8 | 0.1 | 0.1 | 0.2 | 0.02 | 0.08 | — | — | — | — | — | — | — | — | 0.001 | 0.001 | 0.001 | 0.001 | 0.001 |
| STEEL D | 3.3 | 0.5 | 0.1 | — | — | — | — | — | — | — | — | — | — | — | 0.001 | 0.001 | 0.001 | 0.001 | — |
| STEEL E | 3.3 | 0.1 | 0.2 | — | — | — | — | — | — | — | — | — | — | — | 0.001 | 0.001 | 0.001 | 0.001 | — |
| STEEL F | 3.3 | 0.1 | 0.1 | 0.3 | — | — | — | — | — | — | — | — | — | — | 0.001 | 0.001 | 0.001 | 0.001 | — |
| STEEL G | 3.3 | 0.1 | 0.1 | — | 0.2 | — | — | — | — | — | — | — | — | — | 0.001 | 0.001 | 0.001 | 0.001 | — |
| STEEL H | 3.3 | 0.1 | 0.1 | — | — | 0.1 | 0.1 | — | — | — | — | — | — | — | 0.001 | 0.001 | 0.001 | 0.001 | — |
| STEEL I | 3.4 | 0.1 | 0.1 | — | — | — | — | 0.3 | — | — | — | — | — | — | 0.001 | 0.001 | 0.001 | 0.001 | — |
| STEEL J | 3.3 | 0.1 | 0.1 | — | — | — | — | — | 0.001 | — | — | — | — | — | 0.001 | 0.001 | 0.001 | 0.001 | — |
| STEEL K | 3.3 | 0.1 | 0.1 | — | — | — | — | — | — | 0.002 | — | — | — | — | 0.001 | 0.001 | 0.001 | 0.001 | — |
| STEEL L | 3.3 | 0.1 | 0.1 | — | — | — | — | — | — | — | 0.002 | — | — | — | 0.001 | 0.001 | 0.001 | 0.001 | — |
| STEEL M | 3.3 | 0.1 | 0.1 | — | — | — | — | — | — | — | — | 0.05 | — | — | 0.001 | 0.001 | 0.001 | 0.001 | — |
| STEEL N | 3.3 | 0.1 | 0.1 | — | — | — | — | — | — | — | — | — | 0.003 | — | 0.001 | 0.001 | 0.001 | 0.001 | — |
| STEEL O | 3.3 | 0.1 | 0.1 | — | — | — | — | — | — | — | — | — | — | 0.001 | 0.001 | 0.001 | 0.001 | 0.001 | — |

※ IN THE TABLE, “—” INDICATES THAT NO ALLOYING ELEMENT WAS INTENTIONALLY ADDED.

TABLE 2

| | | MANUFACTURING CONDITIONS | | | | | |
|---|---|---|---|---|---|---|---|
| | | | | FORMING INSULATION COATING | | | |
| | | | | | HEAT TREATMENT AFTER BAKING | | |
| | | | | TYPE OF | | | OXIDATION |
| | | APPLYING ANNEALING SEPARATOR | | COATING | | | DEGREE OF |
| | | MgO/(MgO + | HYDRATED | FORMING | MIXED GAS OF ATMOSPHERE | | ATMOSPHERE |
| | | Al₂O₃) | WATER | SOLUTION | HYDROGEN | NITROGEN | PH₂O/PH₂ |
| | | mass % | mass % | — | vol % | vol % | — |
| 1 | STEEL A | 40 | 0.8 | Cr FREE | 75 | 25 | 0.03 |
| 2 | STEEL A | 40 | 0.8 | Cr FREE | 75 | 25 | 0.03 |
| 3 | STEEL A | 40 | 0.8 | Cr FREE | 75 | 25 | 0.03 |
| 4 | STEEL A | 40 | 0.8 | Cr FREE | 75 | 25 | 0.03 |
| 5 | STEEL A | 60 | 0.8 | Cr FREE | 75 | 25 | 0.03 |
| 6 | STEEL A | 100 | 0.8 | Cr FREE | 75 | 25 | 0.03 |
| 7 | STEEL A | 40 | 1.7 | NOT CONDUCTED DUE TO EXCESSIVE | | | |
| | | | | OXIDATION OF STEEL SHEET SURFACE | | | |
| 8 | STEEL A | 40 | 0.8 | Cr FREE | 4 | 96 | 0.03 |
| 9 | STEEL A | 40 | 0.8 | Cr FREE | 75 | 25 | 0.0002 |
| 10 | STEEL A | 40 | 0.8 | Cr FREE | 75 | 25 | 0.18 |
| 11 | STEEL A | 40 | 0.8 | Cr FREE | 75 | 25 | 0.03 |
| 12 | STEEL A | 40 | 0.8 | Cr FREE | 75 | 25 | 0.03 |
| 13 | STEEL A | 40 | 0.8 | Cr FREE | 75 | 25 | 0.03 |
| 14 | STEEL A | 40 | 0.8 | Cr FREE | 75 | 25 | 0.03 |
| 15 | STEEL A | 40 | 0.8 | Cr FREE | 75 | 25 | 0.03 |
| 16 | STEEL A | 40 | 0.8 | Cr FREE | 75 | 25 | 0.03 |
| 17 | STEEL A | 40 | 0.8 | Cr FREE | 75 | 25 | 0.03 |
| 18 | STEEL A | 40 | 0.8 | Cr FREE | 75 | 25 | 0.03 |

| | MANUFACTURING CONDITIONS | | | | | |
|---|---|---|---|---|---|---|
| | FORMING INSULATION COATING | | | | | |
| | | | COOLING AFTER HEAT TREATMENT | | | |
| | | | | | OXIDATION | COOLING |
| | HEAT TREATMENT AFTER BAKING | | | | DEGREE OF | RATE FROM |
| | HOLDING | | MIXED GAS OF ATMOSPHERE | | ATMOSPHERE | 800° C. |
| | TEMPERATURE | TIME | HYDROGEN | NITROGEN | PH₂O/PH₂ | TO 500° C. |
| | ° C. | sec | vol % | vol % | — | ° C./sec |
| 1 | 850 | 30 | 75 | 25 | 0.008 | 15 |
| 2 | 850 | 30 | 75 | 25 | 0.03 | 15 |
| 3 | 850 | 30 | 75 | 25 | 0.008 | 15 |
| 4 | 850 | 30 | 75 | 25 | 0.03 | 15 |
| 5 | 850 | 30 | 75 | 25 | 0.008 | 15 |
| 6 | 850 | 30 | 75 | 25 | 0.008 | 15 |
| 7 | NOT CONDUCTED | — | — | — | — | — |
| | DUE TO EXCESSIVE | | | | | |
| | OXIDATION OF STEEL | | | | | |
| | SHEET SURFACE | | | | | |
| 8 | 850 | 30 | 4 | 96 | 0.007 | 15 |
| 9 | 850 | 30 | 75 | 25 | 0.0002 | 15 |
| 10 | 850 | 30 | 75 | 25 | 0.18 | 15 |
| 11 | 700 | 30 | 75 | 25 | 0.008 | 15 |
| 12 | 850 | 5 | 75 | 25 | 0.008 | 15 |
| 13 | 850 | 30 | 75 | 25 | 0.008 | 50 |
| 14 | 850 | 30 | 75 | 25 | 0.008 | 15 |
| 15 | 850 | 30 | 75 | 25 | 0.008 | 15 |
| 16 | 850 | 30 | 75 | 25 | 0.008 | 15 |
| 17 | 850 | 30 | 75 | 25 | 0.008 | 15 |
| 18 | 850 | 30 | 75 | 25 | 0.008 | 15 |

TABLE 3

| | | MANUFACTURING CONDITIONS | | | | | |
|---|---|---|---|---|---|---|---|
| | | | | FORMING INSULATION COATING | | | |
| | | | | | HEAT TREATMENT AFTER BAKING | | |
| | | | | TYPE OF | | | OXIDATION |
| | | APPLYING ANNEALING SEPARATOR | | COATING | | | DEGREE OF |
| | | MgO/(MgO + | HYDRATED | FORMING | MIXED GAS OF ATMOSPHERE | | ATMOSPHERE |
| | | Al₂O₃) | WATER | SOLUTION | HYDROGEN | NITROGEN | PH₂O/PH₂ |
| | | mass % | mass % | — | vol % | vol % | — |
| 19 | STEEL A | 40 | 0.8 | Cr FREE | 75 | 25 | 0.03 |
| 20 | STEEL A | 40 | 0.8 | Cr FREE | 75 | 25 | 0.03 |
| 21 | STEEL A | 40 | 0.8 | Cr FREE | 75 | 25 | 0.03 |
| 22 | STEEL A | 40 | 0.8 | Cr FREE | 75 | 25 | 0.03 |
| 23 | STEEL A | 40 | 0.8 | Cr FREE | 75 | 25 | 0.03 |
| 24 | STEEL A | 40 | 0.8 | Cr FREE | 75 | 25 | 0.03 |
| 25 | STEEL A | 40 | 0.8 | Cr FREE | 75 | 25 | 0.03 |
| 26 | STEEL A | 40 | 0.8 | Cr FREE | 75 | 25 | 0.03 |
| 27 | STEEL A | 40 | 0.8 | Cr FREE | 75 | 25 | 0.03 |
| 28 | STEEL A | 40 | 0.8 | Cr FREE | 75 | 25 | 0.03 |
| 29 | STEEL A | 40 | 0.8 | Cr FREE | 75 | 25 | 0.03 |
| 30 | STEEL A | 40 | 0.8 | Cr FREE | 75 | 25 | 0.03 |
| 31 | STEEL A | 40 | 0.8 | Cr FREE | 75 | 25 | 0.03 |
| 32 | STEEL A | 40 | 0.8 | Cr FREE | 75 | 25 | 0.03 |
| 33 | STEEL A | 40 | 0.8 | Cr INCLUDED | 75 | 25 | 0.03 |
| 34 | STEEL A | 60 | 0.8 | Cr INCLUDED | 75 | 25 | 0.03 |
| 35 | STEEL B | 40 | 0.8 | Cr FREE | 75 | 25 | 0.03 |
| 36 | STEEL C | 40 | 0.8 | Cr FREE | 75 | 25 | 0.03 |

| | MANUFACTURING CONDITIONS | | | | | |
|---|---|---|---|---|---|---|
| | FORMING INSULATION COATING | | | | | |
| | | | COOLING AFTER HEAT TREATMENT | | | |
| | | | | | OXIDATION | COOLING |
| | HEAT TREATMENT AFTER BAKING | | | | DEGREE OF | RATE FROM |
| | HOLDING | | MIXED GAS OF ATMOSPHERE | | ATMOSPHERE | 800° C. |
| | TEMPERATURE | TIME | HYDROGEN | NITROGEN | PH₂O/PH₂ | TO 500° C. |
| | ° C. | sec | vol % | vol % | — | ° C./sec |
| 19 | 850 | 30 | 75 | 25 | 0.008 | 15 |
| 20 | 850 | 30 | 75 | 25 | 0.008 | 15 |
| 21 | 850 | 30 | 75 | 25 | 0.008 | 15 |
| 22 | 800 | 30 | 75 | 25 | 0.008 | 15 |
| 23 | 900 | 30 | 75 | 25 | 0.008 | 15 |
| 24 | 950 | 30 | 75 | 25 | 0.008 | 15 |
| 25 | 1000 | 30 | 75 | 25 | 0.008 | 15 |
| 26 | 850 | 30 | 75 | 25 | 0.008 | 15 |
| 27 | 850 | 30 | 75 | 25 | 0.008 | 15 |
| 28 | 850 | 30 | 75 | 25 | 0.008 | 15 |
| 29 | 850 | 30 | 75 | 25 | 0.016 | 15 |
| 30 | 850 | 30 | 75 | 25 | 0.023 | 15 |
| 31 | 1000 | 120 | 75 | 25 | 0.008 | 15 |
| 32 | 850 | 30 | 4 | 96 | 0.007 | 15 |
| 33 | 850 | 30 | 75 | 25 | 0.008 | 15 |
| 34 | 850 | 30 | 75 | 25 | 0.008 | 15 |
| 35 | 850 | 30 | 75 | 25 | 0.008 | 15 |
| 36 | 850 | 30 | 75 | 25 | 0.008 | 15 |

TABLE 4

| | | MANUFACTURING CONDITIONS | | | | | |
|---|---|---|---|---|---|---|---|
| | | | | FORMING INSULATION COATING | | | |
| | | | | | HEAT TREATMENT AFTER BAKING | | |
| | | | | TYPE OF | | | OXIDATION |
| | | APPLYING ANNEALING SEPARATOR | | COATING | | | DEGREE OF |
| | | MgO/(MgO + | HYDRATED | FORMING | MIXED GAS OF ATMOSPHERE | | ATMOSPHERE |
| | | Al₂O₃) | WATER | SOLUTION | HYDROGEN | NITROGEN | PH₂O/PH₂ |
| | | mass % | mass % | — | vol % | vol % | — |
| 37 | STEEL D | 40 | 0.8 | Cr FREE | 75 | 25 | 0.03 |
| 38 | STEEL E | 40 | 0.8 | Cr FREE | 75 | 25 | 0.03 |
| 39 | STEEL F | 40 | 0.8 | Cr FREE | 75 | 25 | 0.03 |
| 40 | STEEL G | 40 | 0.8 | Cr FREE | 75 | 25 | 0.03 |
| 41 | STEEL H | 40 | 0.8 | Cr FREE | 75 | 25 | 0.03 |
| 42 | STEEL I | 40 | 0.8 | Cr FREE | 75 | 25 | 0.03 |
| 43 | STEEL J | 40 | 0.8 | Cr FREE | 75 | 25 | 0.03 |
| 44 | STEEL K | 40 | 0.8 | Cr FREE | 75 | 25 | 0.03 |
| 45 | STEEL L | 40 | 0.8 | Cr FREE | 75 | 25 | 0.03 |
| 46 | STEEL M | 40 | 0.8 | Cr FREE | 75 | 25 | 0.03 |
| 47 | STEEL N | 40 | 0.8 | Cr FREE | 75 | 25 | 0.03 |
| 48 | STEEL O | 40 | 0.8 | Cr FREE | 75 | 25 | 0.03 |
| 49 | STEEL A | 40 | 0.8 | Cr FREE | 75 | 25 | 0.03 |
| 50 | STEEL A | 40 | 0.8 | Cr FREE | 75 | 25 | 0.03 |
| 51 | STEEL A | 40 | 0.8 | Cr FREE | 75 | 25 | 0.03 |
| 52 | STEEL A | 40 | 0.8 | Cr FREE | 75 | 25 | 0.03 |
| 53 | STEEL A | 30 | 0.5 | Cr FREE | 75 | 25 | 0.01 |
| 54 | STEEL A | 20 | 0.5 | Cr FREE | 75 | 25 | 0.1 |

| | MANUFACTURING CONDITIONS | | | | | |
|---|---|---|---|---|---|---|
| | FORMING INSULATION COATING | | | | | |
| | | | COOLING AFTER HEAT TREATMENT | | | |
| | | | | | OXIDATION | COOLING |
| | HEAT TREATMENT AFTER BAKING | | | | DEGREE OF | RATE FROM |
| | HOLDING | | MIXED GAS OF ATMOSPHERE | | ATMOSPHERE | 800° C. |
| | TEMPERATURE | TIME | HYDROGEN | NITROGEN | PH₂O/PH₂ | TO 500° C. |
| | ° C. | sec | vol % | vol % | — | ° C./sec |
| 37 | 850 | 30 | 75 | 25 | 0.008 | 15 |
| 38 | 850 | 30 | 75 | 25 | 0.008 | 15 |
| 39 | 850 | 30 | 75 | 25 | 0.008 | 15 |
| 40 | 850 | 30 | 75 | 25 | 0.008 | 15 |
| 41 | 850 | 30 | 75 | 25 | 0.008 | 15 |
| 42 | 850 | 30 | 75 | 25 | 0.008 | 15 |
| 43 | 850 | 30 | 75 | 25 | 0.008 | 15 |
| 44 | 850 | 30 | 75 | 25 | 0.008 | 15 |
| 45 | 850 | 30 | 75 | 25 | 0.008 | 15 |
| 46 | 850 | 30 | 75 | 25 | 0.008 | 15 |
| 47 | 850 | 30 | 75 | 25 | 0.008 | 15 |
| 48 | 850 | 30 | 75 | 25 | 0.008 | 15 |
| 49 | 850 | 30 | 75 | 25 | 0.008 | 15 |
| 50 | 850 | 30 | 75 | 25 | 0.008 | 15 |
| 51 | 850 | 30 | 75 | 25 | 0.008 | 15 |
| 52 | 850 | 30 | 75 | 25 | 0.008 | 15 |
| 53 | 850 | 30 | 75 | 25 | 0.008 | 15 |
| 54 | 850 | 30 | 75 | 25 | 0.008 | 15 |

TABLE 5

| | | MANUFACTURING CONDITIONS | | | | | |
|---|---|---|---|---|---|---|---|
| | | | | FORMING INSULATION COATING | | | |
| | | | | | HEAT TREATMENT AFTER BAKING | | |
| | | | | TYPE OF | | | OXIDATION |
| | | APPLYING ANNEALING SEPARATOR | | COATING | | | DEGREE OF |
| | | MgO/(MgO + | HYDRATED | FORMING | MIXED GAS OF ATMOSPHERE | | ATMOSPHERE |
| | | Al₂O₃) | WATER | SOLUTION | HYDROGEN | NITROGEN | PH₂O/PH₂ |
| | | mass % | mass % | — | vol % | vol % | — |
| 55 | STEEL A | 50 | 0.6 | Cr FREE | 75 | 25 | 0.1 |
| 56 | STEEL A | 50 | 1.4 | Cr FREE | 75 | 25 | 0.03 |
| 57 | STEEL A | 5 | 0.7 | Cr FREE | 75 | 25 | 0.03 |
| 58 | STEEL A | 40 | 0.8 | Cr FREE | 75 | 25 | 0.1 |
| 59 | STEEL A | 40 | 0.8 | Cr FREE | 75 | 25 | 0.01 |
| 60 | STEEL A | 30 | 0.5 | Cr FREE | 75 | 25 | 0.06 |
| 61 | STEEL A | 30 | 0.5 | Cr FREE | 75 | 25 | 0.03 |
| 62 | STEEL A | 30 | 0.5 | Cr FREE | 75 | 25 | 0.03 |
| 63 | STEEL A | 30 | 0.5 | Cr FREE | 75 | 25 | 0.03 |
| 64 | STEEL A | 30 | 0.5 | Cr FREE | 75 | 25 | 0.03 |
| 65 | STEEL A | 30 | 0.5 | Cr FREE | 75 | 25 | 0.03 |
| 66 | STEEL A | 30 | 0.5 | Cr FREE | 75 | 25 | 0.03 |
| 67 | STEEL A | 30 | 0.5 | Cr FREE | 75 | 25 | 0.03 |
| 68 | STEEL A | 30 | 0.5 | Cr FREE | 75 | 25 | 0.03 |
| 69 | STEEL A | 30 | 0.5 | Cr FREE | 75 | 25 | 0.03 |
| 70 | STEEL A | 30 | 0.3 | Cr FREE | 75 | 25 | 0.008 |
| 71 | STEEL A | 45 | 1.4 | Cr FREE | 75 | 25 | 0.1 |
| 72 | STEEL A | 30 | 0.5 | Cr FREE | 75 | 25 | 0.03 |
| 73 | STEEL A | 30 | 0.5 | Cr FREE | 75 | 25 | 0.03 |

| | MANUFACTURING CONDITIONS | | | | | |
|---|---|---|---|---|---|---|
| | FORMING INSULATION COATING | | | | | |
| | | | COOLING AFTER HEAT TREATMENT | | | |
| | | | | | OXIDATION | COOLING |
| | HEAT TREATMENT AFTER BAKING | | | | DEGREE OF | RATE FROM |
| | HOLDING | | MIXED GAS OF ATMOSPHERE | | ATMOSPHERE | 800° C. |
| | TEMPERATURE | TIME | HYDROGEN | NITROGEN | PH₂O/PH₂ | TO 500° C. |
| | ° C. | sec | vol % | vol % | — | ° C./sec |
| 55 | 850 | 30 | 75 | 25 | 0.008 | 15 |
| 56 | 850 | 30 | 75 | 25 | 0.008 | 15 |
| 57 | 850 | 30 | 75 | 25 | 0.008 | 15 |
| 58 | 850 | 30 | 75 | 25 | 0.008 | 15 |
| 59 | 850 | 30 | 75 | 25 | 0.008 | 15 |
| 60 | 850 | 30 | 75 | 25 | 0.06 | 10 |
| 61 | 850 | 30 | 75 | 25 | 0.004 | 40 |
| 62 | 850 | 30 | 75 | 25 | 0.008 | 15 |
| 63 | 850 | 30 | 75 | 25 | 0.008 | 15 |
| 64 | 850 | 30 | 75 | 25 | 0.008 | 15 |
| 65 | 850 | 30 | 75 | 25 | 0.008 | 15 |
| 66 | 850 | 30 | 75 | 25 | 0.008 | 15 |
| 67 | 850 | 30 | 75 | 25 | 0.008 | 15 |
| 68 | 850 | 30 | 75 | 25 | 0.008 | 15 |
| 69 | 850 | 30 | 75 | 25 | 0.008 | 15 |
| 70 | 800 | 10 | 75 | 25 | 0.004 | 15 |
| 71 | 1000 | 110 | 75 | 25 | 0.01 | 15 |
| 72 | 850 | 30 | 75 | 25 | 0.008 | 15 |
| 73 | 850 | 30 | 75 | 25 | 0.008 | 15 |

TABLE 6

| | | MANUFACTURING RESULTS | | | | | | | | | | |
|---|---|---|---|---|---|---|---|---|---|---|---|---|
| | | INTERMEDIATE LAYER | | | | | | INSULATION COATING | | | | |
| | | COMPOSITION (IN UNITS OF ATOMIC %) | | | | | AVERAGE | COMPOSITION (IN UNITS OF ATOMIC %) | | | | |
| | | Si | O | Mg | P | Fe | THICKNESS | P | Si | O | Fe | Cr |
| | | — | — | — | — | — | nm | — | — | — | — | — |
| 1 | STEEL A | 37 | 55 | 2 | 3 | 3 | 20 | 13 | 15 | 62.9 | 7 | 0.1 |
| 2 | STEEL A | 38 | 54 | 2 | 3 | 3 | 18 | 13 | 14 | 62.9 | 7 | 0.1 |
| 3 | STEEL A | 36 | 56 | 2 | 3 | 3 | 21 | 13 | 14 | 62.9 | 7 | 0.1 |
| 4 | STEEL A | 37 | 55 | 2 | 3 | 3 | 23 | 13 | 15 | 62.9 | 7 | 0.1 |
| 5 | STEEL A | 20 | 54 | 21 | 4 | 1 | 694 | 14 | 15 | 64.9 | 3 | 0.1 |
| 6 | STEEL A | 21 | 46 | 28 | 4 | 1 | 1475 | 15 | 16 | 64.9 | 1 | 0.1 |
| 7 | STEEL A | — | — | — | — | — | — | — | — | — | — | — |
| 8 | STEEL A | 37 | 55 | 2 | 3 | 3 | 22 | 13 | 14 | 62.9 | 7 | 0.1 |
| 9 | STEEL A | 37 | 57 | 2 | 3 | 1 | 1 | 13 | 14 | 62.9 | 7 | 0.1 |
| 10 | STEEL A | 24 | 37 | 2 | 5 | 32 | 39 | 13 | 14 | 62.9 | 7 | 0.1 |
| 11 | STEEL A | 37 | 55 | 2 | 3 | 3 | 11 | 13 | 14 | 62.9 | 7 | 0.1 |
| 12 | STEEL A | 38 | 54 | 2 | 3 | 3 | 15 | 13 | 14 | 62.9 | 7 | 0.1 |
| 13 | STEEL A | 39 | 53 | 2 | 3 | 3 | 23 | 13 | 14 | 62.9 | 7 | 0.1 |
| 14 | STEEL A | 37 | 55 | 2 | 3 | 3 | 19 | 13 | 15 | 62.9 | 7 | 0.1 |
| 15 | STEEL A | 36 | 56 | 2 | 3 | 3 | 20 | 13 | 15 | 62.9 | 7 | 0.1 |
| 16 | STEEL A | 37 | 55 | 2 | 3 | 3 | 21 | 13 | 15 | 62.9 | 7 | 0.1 |
| 17 | STEEL A | 37 | 55 | 2 | 3 | 3 | 20 | 13 | 15 | 62.9 | 7 | 0.1 |
| 18 | STEEL A | 36 | 56 | 2 | 3 | 3 | 22 | 13 | 14 | 62.9 | 7 | 0.1 |

TABLE 7

| | | MANUFACTURING RESULTS | | | | | | | | | | |
|---|---|---|---|---|---|---|---|---|---|---|---|---|
| | | INTERMEDIATE LAYER | | | | | | INSULATION COATING | | | | |
| | | COMPOSITION (IN UNITS OF ATOMIC %) | | | | | AVERAGE | COMPOSITION (IN UNITS OF ATOMIC %) | | | | |
| | | Si | O | Mg | P | Fe | THICKNESS | P | Si | O | Fe | Cr |
| | | — | — | — | — | — | nm | — | — | — | — | — |
| 19 | STEEL A | 36 | 56 | 2 | 3 | 3 | 18 | 13 | 14 | 62.9 | 7 | 0.1 |
| 20 | STEEL A | 38 | 54 | 2 | 3 | 3 | 21 | 13 | 14 | 62.9 | 7 | 0.1 |
| 21 | STEEL A | 37 | 55 | 2 | 3 | 3 | 20 | 13 | 14 | 62.9 | 7 | 0.1 |
| 22 | STEEL A | 36 | 56 | 2 | 3 | 3 | 17 | 14 | 15 | 62.9 | 5 | 0.1 |
| 23 | STEEL A | 38 | 54 | 2 | 3 | 3 | 25 | 12 | 13 | 61.9 | 10 | 0.1 |
| 24 | STEEL A | 37 | 55 | 2 | 3 | 3 | 31 | 11 | 12 | 60.9 | 13 | 0.1 |
| 25 | STEEL A | 37 | 55 | 2 | 3 | 3 | 37 | 9 | 10 | 59.9 | 18 | 0.1 |
| 26 | STEEL A | 37 | 55 | 2 | 3 | 3 | 22 | 13 | 14 | 61.9 | 7 | 0.1 |
| 27 | STEEL A | 36 | 56 | 2 | 3 | 3 | 21 | 13 | 14 | 63.4 | 7 | 0.1 |
| 28 | STEEL A | 36 | 56 | 2 | 3 | 3 | 20 | 13 | 14 | 63.7 | 7 | 0.1 |
| 29 | STEEL A | 37 | 55 | 2 | 3 | 3 | 21 | 13 | 14 | 63.7 | 7 | 0.1 |
| 30 | STEEL A | 36 | 56 | 2 | 3 | 3 | 19 | 13 | 14 | 63.7 | 7 | 0.1 |
| 31 | STEEL A | 37 | 55 | 2 | 3 | 3 | 58 | 13 | 14 | 62.9 | 7 | 0.1 |
| 32 | STEEL A | 38 | 54 | 2 | 3 | 3 | 20 | 13 | 14 | 62.9 | 7 | 0.1 |
| 33 | STEEL A | 38 | 54 | 2 | 3 | 3 | 22 | 13 | 14 | 61.5 | 7 | 1.5 |
| 34 | STEEL A | 21 | 53 | 21 | 4 | 1 | 702 | 14 | 15 | 63.5 | 3 | 1.5 |
| 35 | STEEL B | 36 | 56 | 2 | 3 | 3 | 18 | 13 | 14 | 62.9 | 7 | 0.1 |
| 36 | STEEL C | 38 | 54 | 2 | 3 | 3 | 22 | 13 | 14 | 62.9 | 7 | 0.1 |

TABLE 8

| | | MANUFACTURING RESULTS | | | | | | | | | | |
|---|---|---|---|---|---|---|---|---|---|---|---|---|
| | | INTERMEDIATE LAYER | | | | | | INSULATION COATING | | | | |
| | | COMPOSITION (IN UNITS OF ATOMIC %) | | | | | AVERAGE | COMPOSITION (IN UNITS OF ATOMIC %) | | | | |
| | | Si | O | Mg | P | Fe | THICKNESS | P | Si | O | Fe | Cr |
| | | — | — | — | — | — | nm | — | — | — | — | — |
| 37 | STEEL D | 38 | 54 | 2 | 3 | 3 | 20 | 13 | 14 | 62.9 | 7 | 0.1 |
| 38 | STEEL E | 37 | 55 | 2 | 3 | 3 | 19 | 13 | 14 | 62.9 | 7 | 0.1 |
| 39 | STEEL F | 37 | 55 | 2 | 3 | 3 | 20 | 13 | 14 | 62.9 | 7 | 0.1 |
| 40 | STEEL G | 36 | 56 | 2 | 3 | 3 | 21 | 13 | 14 | 62.9 | 7 | 0.1 |
| 41 | STEEL H | 38 | 54 | 2 | 3 | 3 | 18 | 13 | 14 | 62.9 | 7 | 0.1 |
| 42 | STEEL I | 36 | 56 | 2 | 3 | 3 | 21 | 13 | 14 | 62.9 | 7 | 0.1 |
| 43 | STEEL J | 37 | 55 | 2 | 3 | 3 | 20 | 13 | 14 | 62.9 | 7 | 0.1 |
| 44 | STEEL K | 36 | 56 | 2 | 3 | 3 | 19 | 13 | 14 | 62.9 | 7 | 0.1 |
| 45 | STEEL L | 37 | 55 | 2 | 3 | 3 | 19 | 13 | 14 | 62.9 | 7 | 0.1 |
| 46 | STEEL M | 37 | 55 | 2 | 3 | 3 | 21 | 13 | 14 | 62.9 | 7 | 0.1 |
| 47 | STEEL N | 38 | 54 | 2 | 3 | 3 | 20 | 13 | 14 | 62.9 | 7 | 0.1 |
| 48 | STEEL O | 36 | 56 | 2 | 3 | 3 | 18 | 13 | 14 | 62.9 | 7 | 0.1 |
| 49 | STEEL A | 37 | 55 | 2 | 3 | 3 | 19 | 13 | 15 | 61.8 | 7 | 0.1 |
| 50 | STEEL A | 36 | 56 | 2 | 3 | 3 | 20 | 13 | 15 | 61.9 | 7 | 0.1 |
| 51 | STEEL A | 37 | 55 | 2 | 3 | 3 | 21 | 13 | 15 | 61.9 | 7 | 0.1 |
| 52 | STEEL A | 37 | 55 | 2 | 3 | 3 | 20 | 13 | 15 | 61.9 | 7 | 0.1 |
| 53 | STEEL A | 43 | 45 | 4 | 4 | 4 | 13 | 13 | 14 | 61.9 | 8 | 0.1 |
| 54 | STEEL A | 30 | 67 | 1 | 1 | 1 | 24 | 13 | 14 | 64.9 | 5 | 0.1 |

TABLE 9

| | | MANUFACTURING RESULTS | | | | | | | | | | |
|---|---|---|---|---|---|---|---|---|---|---|---|---|
| | | INTERMEDIATE LAYER | | | | | | INSULATION COATING | | | | |
| | | COMPOSITION (IN UNITS OF ATOMIC %) | | | | | AVERAGE | COMPOSITION (IN UNITS OF ATOMIC %) | | | | |
| | | Si | O | Mg | P | Fe | THICKNESS | P | Si | O | Fe | Cr |
| | | — | — | — | — | — | nm | — | — | — | — | — |
| 55 | STEEL A | 27 | 53 | 16 | 2 | 2 | 31 | 14 | 15 | 60.9 | 7 | 0.1 |
| 56 | STEEL A | 36 | 39 | 19 | 3 | 3 | 25 | 13 | 14 | 62.9 | 7 | 0.1 |
| 57 | STEEL A | 36 | 57.5 | 0.5 | 3 | 3 | 20 | 13 | 14 | 62.9 | 7 | 0.1 |
| 58 | STEEL A | 36 | 55 | 2 | 4 | 3 | 25 | 14 | 14 | 61.9 | 7 | 0.1 |
| 59 | STEEL A | 36 | 58.5 | 2 | 0.5 | 3 | 15 | 13 | 14 | 62.9 | 7 | 0.1 |
| 60 | STEEL A | 36 | 40 | 2 | 3 | 19 | 22 | 12 | 15 | 62.9 | 7 | 0.1 |
| 61 | STEEL A | 36 | 58 | 2 | 3 | 1 | 18 | 13 | 14 | 62.9 | 7 | 0.1 |
| 62 | STEEL A | 37 | 55 | 2 | 3 | 3 | 19 | 15 | 9 | 61.7 | 4 | 0.9 |
| 63 | STEEL A | 36 | 56 | 2 | 3 | 3 | 20 | 9 | 18 | 63.6 | 2 | 0.1 |
| 64 | STEEL A | 36 | 56 | 2 | 3 | 3 | 18 | 15 | 8 | 62.2 | 3 | 0.1 |
| 65 | STEEL A | 37 | 55 | 2 | 3 | 3 | 21 | 9 | 17 | 63.2 | 2 | 0.1 |
| 66 | STEEL A | 36 | 56 | 2 | 3 | 3 | 19 | 16 | 9 | 60.4 | 5 | 0.1 |
| 67 | STEEL A | 36 | 56 | 2 | 3 | 3 | 20 | 9 | 18 | 60.7 | 3 | 0.1 |
| 68 | STEEL A | 38 | 54 | 2 | 3 | 3 | 19 | 16 | 8 | 60.0 | 4 | 0.1 |
| 69 | STEEL A | 36 | 56 | 2 | 3 | 3 | 19 | 10 | 18 | 60.1 | 2 | 0.1 |
| 70 | STEEL A | 40 | 55 | 1 | 2 | 2 | 3 | 14 | 15 | 62.9 | 5 | 0.1 |
| 71 | STEEL A | 33 | 57 | 3 | 2 | 5 | 490 | 14 | 15 | 58.9 | 9 | 0.1 |
| 72 | STEEL A | 37 | 55 | 2 | 3 | 3 | 21 | 13 | 14 | 62.9 | 7 | 0.1 |
| 73 | STEEL A | 38 | 54 | 2 | 3 | 3 | 21 | 13 | 14 | 62.9 | 7 | 0.1 |

TABLE 10

| | | MANUFACTURING RESULTS | | | | | | | | | | | | |
|---|---|---|---|---|---|---|---|---|---|---|---|---|---|---|
| | | INSULATION COATING | | | | | | | | | | | | |
| | | COMPOSITION (IN UNITS OF ATOMIC %) | | | | | | | | | | | | |
| | | | | | | | | | | | | TOTAL | TOTAL | |
| | | Al | Mg | Mn | Ni | Zn | V | W | Zr | Co | Mo | AMOUNT | AMOUNT | AVERAGE |
| | | (a) | (a) | (a) | (a) | (a) | (b) | (b) | (b) | (b) | (b) | OF (a) | OF (b) | THICKNESS |
| | | — | — | — | — | — | — | — | — | — | — | — | — | μm |
| 1 | STEEL A | 2 | — | — | — | — | — | — | — | — | — | 2.0 | 0.0 | 2 |
| 2 | STEEL A | 2 | — | — | — | — | 1 | — | — | — | — | 2.0 | 1.0 | 2 |
| 3 | STEEL A | 2 | — | — | — | — | 1 | — | — | — | — | 2.0 | 1.0 | 2 |
| 4 | STEEL A | 2 | — | — | — | — | — | — | — | — | — | 2.0 | 0.0 | 2 |
| 5 | STEEL A | 2 | — | — | — | — | 1 | — | — | — | — | 2.0 | 1.0 | 2 |
| 6 | STEEL A | 2 | — | — | — | — | 1 | — | — | — | — | 2.0 | 1.0 | 2 |
| 7 | STEEL A | — | — | — | — | — | — | — | — | — | — | — | — | — |
| 8 | STEEL A | 2 | — | — | — | — | 1 | — | — | — | — | 2.0 | 1.0 | 2 |
| 9 | STEEL A | 2 | — | — | — | — | 1 | — | — | — | — | 2.0 | 1.0 | 2 |
| 10 | STEEL A | 2 | — | — | — | — | 1 | — | — | — | — | 2.0 | 1.0 | 2 |
| 11 | STEEL A | 2 | — | — | — | — | 1 | — | — | — | — | 2.0 | 1.0 | 2 |
| 12 | STEEL A | 2 | — | — | — | — | 1 | — | — | — | — | 2.0 | 1.0 | 2 |
| 13 | STEEL A | 2 | — | — | — | — | 1 | — | — | — | — | 2.0 | 1.0 | 2 |
| 14 | STEEL A | — | 2 | — | — | — | — | — | — | — | — | 2.0 | 0.0 | 2 |
| 15 | STEEL A | — | — | 2 | — | — | — | — | — | — | — | 2.0 | 0.0 | 2 |
| 16 | STEEL A | — | — | — | 2 | — | — | — | — | — | — | 2.0 | 0.0 | 2 |
| 17 | STEEL A | — | — | — | — | 2 | — | — | — | — | — | 2.0 | 0.0 | 2 |
| 18 | STEEL A | 2 | — | — | — | — | — | 1 | — | — | — | 2.0 | 1.0 | 2 |

TABLE 11

| | | MANUFACTURING RESULTS | | | | | | | | | | | | |
|---|---|---|---|---|---|---|---|---|---|---|---|---|---|---|
| | | INSULATION COATING | | | | | | | | | | | | |
| | | COMPOSITION (IN UNITS OF ATOMIC %) | | | | | | | | | | | | |
| | | | | | | | | | | | | TOTAL | TOTAL | |
| | | Al | Mg | Mn | Ni | Zn | V | W | Zr | Co | Mo | AMOUNT | AMOUNT | AVERAGE |
| | | (a) | (a) | (a) | (a) | (a) | (b) | (b) | (b) | (b) | (b) | OF (a) | OF (b) | THICKNESS |
| | | — | — | — | — | — | — | — | — | — | — | — | — | μm |
| 19 | STEEL A | 2 | — | — | — | — | — | — | 1 | — | — | 2.0 | 1.0 | 2 |
| 20 | STEEL A | 2 | — | — | — | — | — | — | — | 1 | — | 2.0 | 1.0 | 2 |
| 21 | STEEL A | 2 | — | — | — | — | — | — | — | — | 1 | 2.0 | 1.0 | 2 |
| 22 | STEEL A | 2 | — | — | — | — | 1 | — | — | — | — | 2.0 | 1.0 | 2 |
| 23 | STEEL A | 2 | — | — | — | — | 1 | — | — | — | — | 2.0 | 1.0 | 2 |
| 24 | STEEL A | 2 | — | — | — | — | 1 | — | — | — | — | 2.0 | 1.0 | 2 |
| 25 | STEEL A | 2 | — | — | — | — | 1 | — | — | — | — | 2.0 | 1.0 | 2 |
| 26 | STEEL A | 2 | — | — | — | — | 2 | — | — | — | — | 2.0 | 2.0 | 2 |
| 27 | STEEL A | 2 | — | — | — | — | 0.5 | — | — | — | — | 2.0 | 0.5 | 2 |
| 28 | STEEL A | 2 | — | — | — | — | 0.2 | — | — | — | — | 2.0 | 0.2 | 2 |
| 29 | STEEL A | 2 | — | — | — | — | 0.2 | — | — | — | — | 2.0 | 0.2 | 2 |
| 30 | STEEL A | 2 | — | — | — | — | 0.2 | — | — | — | — | 2.0 | 0.2 | 2 |
| 31 | STEEL A | 2 | — | — | — | — | 1 | — | — | — | — | 2.0 | 1.0 | 2 |
| 32 | STEEL A | 2 | — | — | — | — | 1 | — | — | — | — | 2.0 | 1.0 | 2 |
| 33 | STEEL A | 2 | — | — | — | — | 1 | — | — | — | — | 2.0 | 1.0 | 2 |
| 34 | STEEL A | 2 | — | — | — | — | 1 | — | — | — | — | 2.0 | 1.0 | 2 |
| 35 | STEEL B | 2 | — | — | — | — | 1 | — | — | — | — | 2.0 | 1.0 | 2 |
| 36 | STEEL C | 2 | — | — | — | — | 1 | — | — | — | — | 2.0 | 1.0 | 2 |

TABLE 12

| | | MANUFACTURING RESULTS | | | | | | | | | | | | |
|---|---|---|---|---|---|---|---|---|---|---|---|---|---|---|
| | | INSULATION COATING | | | | | | | | | | | | |
| | | COMPOSITION (IN UNITS OF ATOMIC %) | | | | | | | | | | | | |
| | | | | | | | | | | | | TOTAL | TOTAL | |
| | | Al | Mg | Mn | Ni | Zn | V | W | Zr | Co | Mo | AMOUNT | AMOUNT | AVERAGE |
| | | (a) | (a) | (a) | (a) | (a) | (b) | (b) | (b) | (b) | (b) | OF (a) | OF (b) | THICKNESS |
| | | — | — | — | — | — | — | — | — | — | — | — | — | μm |
| 37 | STEEL D | 2 | — | — | — | — | 1 | — | — | — | — | 2.0 | 1.0 | 2 |
| 38 | STEEL E | 2 | — | — | — | — | 1 | — | — | — | — | 2.0 | 1.0 | 2 |
| 39 | STEEL F | 2 | — | — | — | — | 1 | — | — | — | — | 2.0 | 1.0 | 2 |
| 40 | STEEL G | 2 | — | — | — | — | 1 | — | — | — | — | 2.0 | 1.0 | 2 |
| 41 | STEEL H | 2 | — | — | — | — | 1 | — | — | — | — | 2.0 | 1.0 | 2 |
| 42 | STEEL I | 2 | — | — | — | — | 1 | — | — | — | — | 2.0 | 1.0 | 2 |
| 43 | STEEL J | 2 | — | — | — | — | 1 | — | — | — | — | 2.0 | 1.0 | 2 |
| 44 | STEEL K | 2 | — | — | — | — | 1 | — | — | — | — | 2.0 | 1.0 | 2 |
| 45 | STEEL L | 2 | — | — | — | — | 1 | — | — | — | — | 2.0 | 1.0 | 2 |
| 46 | STEEL M | 2 | — | — | — | — | 1 | — | — | — | — | 2.0 | 1.0 | 2 |
| 47 | STEEL N | 2 | — | — | — | — | 1 | — | — | — | — | 2.0 | 1.0 | 2 |
| 48 | STEEL O | 2 | — | — | — | — | 1 | — | — | — | — | 2.0 | 1.0 | 2 |
| 49 | STEEL A | 0.1 | 2 | — | — | — | 1 | — | — | — | — | 2.1 | 1.0 | 2 |
| 50 | STEEL A | — | — | 2 | — | — | 1 | — | — | — | — | 2.0 | 1.0 | 2 |
| 51 | STEEL A | — | — | — | 2 | — | 1 | — | — | — | — | 2.0 | 1.0 | 2 |
| 52 | STEEL A | — | — | — | — | 2 | 1 | — | — | — | — | 2.0 | 1.0 | 2 |
| 53 | STEEL A | 2 | — | — | — | — | 1 | — | — | — | — | 2.0 | 1.0 | 2 |
| 54 | STEEL A | 2 | — | — | — | — | 1 | — | — | — | — | 2.0 | 1.0 | 2 |

TABLE 13

| | | MANUFACTURING RESULTS | | | | | | | | | | | | |
|---|---|---|---|---|---|---|---|---|---|---|---|---|---|---|
| | | INSULATION COATING | | | | | | | | | | | | |
| | | COMPOSITION (IN UNITS OF ATOMIC %) | | | | | | | | | | | | |
| | | | | | | | | | | | | TOTAL | TOTAL | |
| | | Al | Mg | Mn | Ni | Zn | V | W | Zr | Co | Mo | AMOUNT | AMOUNT | AVERAGE |
| | | (a) | (a) | (a) | (a) | (a) | (b) | (b) | (b) | (b) | (b) | OF (a) | OF (b) | THICKNESS |
| | | — | — | — | — | — | — | — | — | — | — | — | — | μm |
| 55 | STEEL A | 2 | — | — | — | — | 1 | — | — | — | — | 2.0 | 1.0 | 2 |
| 56 | STEEL A | 2 | — | — | — | — | 1 | — | — | — | — | 2.0 | 1.0 | 2 |
| 57 | STEEL A | 2 | — | — | — | — | 1 | — | — | — | — | 2.0 | 1.0 | 2 |
| 58 | STEEL A | 2 | — | — | — | — | 1 | — | — | — | — | 2.0 | 1.0 | 2 |
| 59 | STEEL A | 2 | — | — | — | — | 1 | — | — | — | — | 2.0 | 1.0 | 2 |
| 60 | STEEL A | 2 | — | — | — | — | 1 | — | — | — | — | 2.0 | 1.0 | 2 |
| 61 | STEEL A | 2 | — | — | — | — | 1 | — | — | — | — | 2.0 | 1.0 | 2 |
| 62 | STEEL A | 9 | — | — | — | — | 0.4 | — | — | — | — | 9.0 | 0.4 | 2 |
| 63 | STEEL A | 7 | — | — | — | — | 0.3 | — | — | — | — | 7.0 | 0.3 | 2 |
| 64 | STEEL A | 9 | — | — | — | — | 2.7 | — | — | — | — | 9.0 | 2.7 | 2 |
| 65 | STEEL A | 7 | — | — | — | — | 1.7 | — | — | — | — | 7.0 | 1.7 | 2 |
| 66 | STEEL A | 9 | — | — | — | — | 0.5 | — | — | — | — | 9.0 | 0.5 | 2 |
| 67 | STEEL A | 9 | — | — | — | — | 0.2 | — | — | — | — | 9.0 | 0.2 | 2 |
| 68 | STEEL A | 9 | — | — | — | — | 2.9 | — | — | — | — | 9.0 | 2.9 | 2 |
| 69 | STEEL A | 8 | — | — | — | — | 1.8 | — | — | — | — | 8.0 | 1.8 | 2 |
| 70 | STEEL A | 2 | — | — | — | — | 1 | — | — | — | — | 2.0 | 1.0 | 2 |
| 71 | STEEL A | 2 | — | — | — | — | 1 | — | — | — | — | 2.0 | 1.0 | 2 |
| 72 | STEEL A | 2 | — | — | — | — | 1 | — | — | — | — | 2.0 | 1.0 | 0.2 |
| 73 | STEEL A | 2 | — | — | — | — | 1 | — | — | — | — | 2.0 | 1.0 | 9 |

TABLE 14

| | | MANUFACTURING RESULTS | | | | | | | |
|---|---|---|---|---|---|---|---|---|---|
| | | INSULATION COATING | | | | | | | |
| | | CRYSTALLINE PHOSPHORUS OXIDE | | | | | | | |
| | | | | | | TOTAL AREA FRACTION | | AREA RATIO OF | |
| | | EXISTENCE | SECOND CRYSTALLINE PHOSPHOROUS OXIDE | | | OF FIRST AND SECOND | | SECOND CRYSTALLINE | |
| | | OF FIRST | | EXISTENCE | AVERAGE | CRYSTALLINE | | PHOSPHOROUS OXIDE | |
| | | CRYSTALLINE | | OF | EQUIVALENT | PHOSPHOROUS OXIDES | | IN INTERNAL REGION | |
| | | PHOSPHORUS | | V, W, Zr, | CIRCLE | SURFACE | INTERNAL | FIRST | SECOND |
| | | OXIDE | EXISTENCE | Co, OR Mo | DIAMETER | REGION | REGION | REGION | REGION |
| | | — | — | — | nm | area % | area % | % | % |
| 1 | STEEL A | EXISTENCE | EXISTENCE | — | 34 | 0 | 6 | 21 | 48 |
| 2 | STEEL A | EXISTENCE | EXISTENCE | EXISTENCE(V) | 37 | 0 | 11 | 37 | 76 |
| 3 | STEEL A | EXISTENCE | EXISTENCE | EXISTENCE(V) | 38 | 0 | 25 | 64 | 93 |
| 4 | STEEL A | EXISTENCE | NONE | — | — | 0 | 10 | — | — |
| 5 | STEEL A | NONE | NONE | — | — | — | — | — | — |
| 6 | STEEL A | NONE | NONE | — | — | — | — | — | — |
| 7 | STEEL A | — | — | — | — | — | — | — | — |
| 8 | STEEL A | EXISTENCE | NONE | — | — | 0 | 8 | — | — |
| 9 | STEEL A | EXISTENCE | EXISTENCE | EXISTENCE(V) | 36 | 0 | 26 | 63 | 94 |
| 10 | STEEL A | EXISTENCE | EXISTENCE | EXISTENCE(V) | 38 | 0 | 23 | 66 | 93 |
| 11 | STEEL A | EXISTENCE | NONE | — | 35 | 0 | 26 | — | — |
| 12 | STEEL A | EXISTENCE | NONE | — | 36 | 0 | 7 | — | — |
| 13 | STEEL A | EXISTENCE | NONE | — | 33 | 0 | 23 | — | — |
| 14 | STEEL A | EXISTENCE | EXISTENCE | — | 32 | 0 | 5 | 18 | 53 |
| 15 | STEEL A | EXISTENCE | EXISTENCE | — | 34 | 0 | 6 | 23 | 52 |
| 16 | STEEL A | EXISTENCE | EXISTENCE | — | 33 | 0 | 4 | 21 | 49 |
| 17 | STEEL A | EXISTENCE | EXISTENCE | — | 31 | 0 | 7 | 21 | 53 |
| 18 | STEEL A | EXISTENCE | EXISTENCE | EXISTENCE(W) | 36 | 0 | 24 | 67 | 95 |

TABLE 15

| | | MANUFACTURING RESULTS | | | | | | | |
|---|---|---|---|---|---|---|---|---|---|
| | | INSULATION COATING | | | | | | | |
| | | CRYSTALLINE PHOSPHORUS OXIDE | | | | | | | |
| | | | | | | TOTAL AREA FRACTION | | AREA RATIO OF | |
| | | EXISTENCE | SECOND CRYSTALLINE PHOSPHOROUS OXIDE | | | OF FIRST AND SECOND | | SECOND CRYSTALLINE | |
| | | OF FIRST | | EXISTENCE | AVERAGE | CRYSTALLINE | | PHOSPHOROUS OXIDE | |
| | | CRYSTALLINE | | OF | EQUIVALENT | PHOSPHOROUS OXIDES | | IN INTERNAL REGION | |
| | | PHOSPHORUS | | V, W, Zr, | CIRCLE | SURFACE | INTERNAL | FIRST | SECOND |
| | | OXIDE | EXISTENCE | Co, OR Mo | DIAMETER | REGION | REGION | REGION | REGION |
| | | — | — | — | nm | area % | area % | % | % |
| 19 | STEEL A | EXISTENCE | EXISTENCE | EXISTENCE(Zr) | 33 | 0 | 23 | 64 | 93 |
| 20 | STEEL A | EXISTENCE | EXISTENCE | EXISTENCE(Co) | 32 | 0 | 22 | 64 | 92 |
| 21 | STEEL A | EXISTENCE | EXISTENCE | EXISTENCE (Mo) | 37 | 0 | 24 | 66 | 95 |
| 22 | STEEL A | EXISTENCE | EXISTENCE | EXISTENCE(V) | 26 | 0 | 14 | 71 | 94 |
| 23 | STEEL A | EXISTENCE | EXISTENCE | EXISTENCE(V) | 64 | 0 | 36 | 59 | 83 |
| 24 | STEEL A | EXISTENCE | EXISTENCE | EXISTENCE(V) | 108 | 18 | 51 | 54 | 82 |
| 25 | STEEL A | EXISTENCE | EXISTENCE | EXISTENCE(V) | 211 | 33 | 55 | 49 | 72 |
| 26 | STEEL A | EXISTENCE | EXISTENCE | EXISTENCE(V) | 32 | 0 | 33 | 77 | 100 |
| 27 | STEEL A | EXISTENCE | EXISTENCE | EXISTENCE(V) | 36 | 0 | 16 | 54 | 77 |
| 28 | STEEL A | EXISTENCE | EXISTENCE | EXISTENCE(V) | 36 | 0 | 9 | 43 | 64 |
| 29 | STEEL A | EXISTENCE | EXISTENCE | EXISTENCE(V) | 34 | 0 | 12 | 46 | 52 |
| 30 | STEEL A | EXISTENCE | EXISTENCE | EXISTENCE(V) | 35 | 0 | 8 | 44 | 46 |
| 31 | STEEL A | EXISTENCE | EXISTENCE | EXISTENCE(V) | 307 | 62 | 67 | 55 | 62 |
| 32 | STEEL A | EXISTENCE | NONE | — | — | 0 | 10 | — | — |
| 33 | STEEL A | EXISTENCE | NONE | — | — | 0 | 26 | — | — |
| 34 | STEEL A | NONE | NONE | — | — | — | — | — | — |
| 35 | STEEL B | EXISTENCE | EXISTENCE | EXISTENCE(V) | 35 | 0 | 23 | 64 | 96 |
| 36 | STEEL C | EXISTENCE | EXISTENCE | EXISTENCE(V) | 33 | 0 | 25 | 66 | 94 |

TABLE 16

| | | MANUFACTURING RESULTS | | | | | | | |
|---|---|---|---|---|---|---|---|---|---|
| | | INSULATION COATING | | | | | | | |
| | | CRYSTALLINE PHOSPHORUS OXIDE | | | | | | | |
| | | | | | | TOTAL AREA FRACTION | | AREA RATIO OF | |
| | | EXISTENCE | SECOND CRYSTALLINE PHOSPHOROUS OXIDE | | | OF FIRST AND SECOND | | SECOND CRYSTALLINE | |
| | | OF FIRST | | EXISTENCE | AVERAGE | CRYSTALLINE | | PHOSPHOROUS OXIDE | |
| | | CRYSTALLINE | | OF | EQUIVALENT | PHOSPHOROUS OXIDES | | IN INTERNAL REGION | |
| | | PHOSPHORUS | | V, W, Zr, | CIRCLE | SURFACE | INTERNAL | FIRST | SECOND |
| | | OXIDE | EXISTENCE | Co, OR Mo | DIAMETER | REGION | REGION | REGION | REGION |
| | | — | — | — | nm | area % | area % | % | % |
| 37 | STEEL D | EXISTENCE | EXISTENCE | EXISTENCE(V) | 34 | 0 | 24 | 64 | 93 |
| 38 | STEEL E | EXISTENCE | EXISTENCE | EXISTENCE(V) | 37 | 0 | 27 | 66 | 96 |
| 39 | STEEL F | EXISTENCE | EXISTENCE | EXISTENCE(V) | 32 | 0 | 26 | 67 | 97 |
| 40 | STEEL G | EXISTENCE | EXISTENCE | EXISTENCE(V) | 37 | 0 | 23 | 66 | 94 |
| 41 | STEEL H | EXISTENCE | EXISTENCE | EXISTENCE(V) | 36 | 0 | 24 | 63 | 95 |
| 42 | STEEL I | EXISTENCE | EXISTENCE | EXISTENCE(V) | 35 | 0 | 26 | 66 | 94 |
| 43 | STEEL J | EXISTENCE | EXISTENCE | EXISTENCE(V) | 36 | 0 | 25 | 63 | 94 |
| 44 | STEEL K | EXISTENCE | EXISTENCE | EXISTENCE(V) | 33 | 0 | 27 | 67 | 95 |
| 45 | STEEL L | EXISTENCE | EXISTENCE | EXISTENCE(V) | 33 | 0 | 23 | 64 | 96 |
| 46 | STEEL M | EXISTENCE | EXISTENCE | EXISTENCE(V) | 35 | 0 | 25 | 66 | 93 |
| 47 | STEEL N | EXISTENCE | EXISTENCE | EXISTENCE(V) | 36 | 0 | 24 | 65 | 96 |
| 48 | STEEL O | EXISTENCE | EXISTENCE | EXISTENCE(V) | 31 | 0 | 22 | 62 | 93 |
| 49 | STEEL A | EXISTENCE | EXISTENCE | EXISTENCE(V) | 33 | 0 | 23 | 64 | 91 |
| 50 | STEEL A | EXISTENCE | EXISTENCE | EXISTENCE(V) | 34 | 0 | 25 | 62 | 93 |
| 51 | STEEL A | EXISTENCE | EXISTENCE | EXISTENCE(V) | 34 | 0 | 22 | 65 | 90 |
| 52 | STEEL A | EXISTENCE | EXISTENCE | EXISTENCE(V) | 32 | 0 | 23 | 66 | 94 |
| 53 | STEEL A | EXISTENCE | EXISTENCE | EXISTENCE(V) | 34 | 0 | 26 | 66 | 94 |
| 54 | STEEL A | EXISTENCE | EXISTENCE | EXISTENCE(V) | 39 | 0 | 23 | 62 | 91 |

TABLE 17

| | | MANUFACTURING RESULTS | | | | | | | |
|---|---|---|---|---|---|---|---|---|---|
| | | INSULATION COATING | | | | | | | |
| | | CRYSTALLINE PHOSPHORUS OXIDE | | | | | | | |
| | | | | | | TOTAL AREA FRACTION | | AREA RATIO OF | |
| | | EXISTENCE | SECOND CRYSTALLINE PHOSPHOROUS OXIDE | | | OF FIRST AND SECOND | | SECOND CRYSTALLINE | |
| | | OF FIRST | | EXISTENCE | AVERAGE | CRYSTALLINE | | PHOSPHOROUS OXIDE | |
| | | CRYSTALLINE | | OF | EQUIVALENT | PHOSPHOROUS OXIDES | | IN INTERNAL REGION | |
| | | PHOSPHORUS | | V, W, Zr, | CIRCLE | SURFACE | INTERNAL | FIRST | SECOND |
| | | OXIDE | EXISTENCE | Co, OR Mo | DIAMETER | REGION | REGION | REGION | REGION |
| | | — | — | — | nm | area % | area % | % | % |
| 55 | STEEL A | EXISTENCE | EXISTENCE | EXISTENCE(V) | 40 | 0 | 25 | 64 | 93 |
| 56 | STEEL A | EXISTENCE | EXISTENCE | EXISTENCE(V) | 38 | 0 | 24 | 63 | 91 |
| 57 | STEEL A | EXISTENCE | EXISTENCE | EXISTENCE(V) | 38 | 0 | 25 | 64 | 93 |
| 58 | STEEL A | EXISTENCE | EXISTENCE | EXISTENCE(V) | 38 | 0 | 24 | 62 | 91 |
| 59 | STEEL A | EXISTENCE | EXISTENCE | EXISTENCE(V) | 38 | 0 | 25 | 64 | 93 |
| 60 | STEEL A | EXISTENCE | EXISTENCE | EXISTENCE(V) | 38 | 0 | 26 | 67 | 94 |
| 61 | STEEL A | EXISTENCE | EXISTENCE | EXISTENCE(V) | 38 | 0 | 25 | 64 | 94 |
| 62 | STEEL A | EXISTENCE | EXISTENCE | EXISTENCE(V) | 35 | 0 | 11 | 48 | 73 |
| 63 | STEEL A | EXISTENCE | EXISTENCE | EXISTENCE(V) | 33 | 0 | 9 | 44 | 68 |
| 64 | STEEL A | EXISTENCE | EXISTENCE | EXISTENCE(V) | 42 | 0 | 27 | 67 | 94 |
| 65 | STEEL A | EXISTENCE | EXISTENCE | EXISTENCE(V) | 41 | 0 | 23 | 52 | 85 |
| 66 | STEEL A | EXISTENCE | EXISTENCE | EXISTENCE(V) | 36 | 0 | 11 | 42 | 76 |
| 67 | STEEL A | EXISTENCE | EXISTENCE | EXISTENCE(V) | 33 | 0 | 8 | 35 | 51 |
| 68 | STEEL A | EXISTENCE | EXISTENCE | EXISTENCE(V) | 44 | 0 | 28 | 68 | 95 |
| 69 | STEEL A | EXISTENCE | EXISTENCE | EXISTENCE(V) | 39 | 0 | 26 | 53 | 86 |
| 70 | STEEL A | EXISTENCE | EXISTENCE | EXISTENCE(V) | 26 | 0 | 23 | 52 | 87 |
| 71 | STEEL A | EXISTENCE | EXISTENCE | EXISTENCE(V) | 26 | 0 | 26 | 67 | 95 |
| 72 | STEEL A | EXISTENCE | EXISTENCE | EXISTENCE(V) | 39 | 0 | 31 | 67 | 95 |
| 73 | STEEL A | EXISTENCE | EXISTENCE | EXISTENCE(V) | 36 | 0 | 25 | 58 | 89 |

TABLE 18

| | | EVALUATION RESULTS | | | |
|---|---|---|---|---|---|
| | | | COATING ADHESION | | |
| | | | CYLINDER | CYLINDER | |
| | | IRON LOSS | WITH | WITH | |
| | | W17/50 | 20 mm OF | 15 mm OF | |
| | | W/kg | DIAMETER | DIAMETER | NOTE |
| 1 | STEEL A | 0.63 | Very Good | Poor | COMPARATIVE EXAMPLE |
| 2 | STEEL A | 0.63 | Very Good | Good | INVENTIVE EXAMPLE |
| 3 | STEEL A | 0.63 | Very Good | Very Good | INVENTIVE EXAMPLE |
| 4 | STEEL A | 0.68 | Poor | NG | COMPARATIVE EXAMPLE |
| 5 | STEEL A | NOT EVALUATED | NOT EVALUATED | NOT EVALUATED | COMPARATIVE EXAMPLE |
| 6 | STEEL A | NOT EVALUATED | NOT EVALUATED | NOT EVALUATED | COMPARATIVE EXAMPLE |
| 7 | STEEL A | — | — | — | COMPARATIVE EXAMPLE |
| 8 | STEEL A | 0.67 | Poor | NG | COMPARATIVE EXAMPLE |
| 9 | STEEL A | 0.68 | NG | NG | COMPARATIVE EXAMPLE |
| 10 | STEEL A | 0.71 | NG | NG | COMPARATIVE EXAMPLE |
| 11 | STEEL A | 0.68 | Good | NG | COMPARATIVE EXAMPLE |
| 12 | STEEL A | 0.68 | Poor | NG | COMPARATIVE EXAMPLE |
| 13 | STEEL A | 0.68 | Good | NG | COMPARATIVE EXAMPLE |
| 14 | STEEL A | 0.63 | Very Good | Poor | COMPARATIVE EXAMPLE |
| 15 | STEEL A | 0.63 | Very Good | Poor | COMPARATIVE EXAMPLE |
| 16 | STEEL A | 0.63 | Very Good | Poor | COMPARATIVE EXAMPLE |
| 17 | STEEL A | 0.63 | Very Good | Poor | COMPARATIVE EXAMPLE |
| 18 | STEEL A | 0.63 | Very Good | Very Good | INVENTIVE EXAMPLE |

TABLE 19

| | | EVALUATION RESULTS | | | |
|---|---|---|---|---|---|
| | | | COATING ADHESION | | |
| | | | CYLINDER | CYLINDER | |
| | | IRON LOSS | WITH | WITH | |
| | | W17/50 | 20 mm OF | 15 mm OF | |
| | | W/kg | DIAMETER | DIAMETER | NOTE |
| 19 | STEEL A | 0.63 | Very Good | Very Good | INVENTIVE EXAMPLE |
| 20 | STEEL A | 0.63 | Very Good | Very Good | INVENTIVE EXAMPLE |
| 21 | STEEL A | 0.63 | Very Good | Very Good | INVENTIVE EXAMPLE |
| 22 | STEEL A | 0.63 | Very Good | Very Good | INVENTIVE EXAMPLE |
| 23 | STEEL A | 0.63 | Very Good | Very Good | INVENTIVE EXAMPLE |
| 24 | STEEL A | 0.63 | Very Good | Very Good | INVENTIVE EXAMPLE |
| 25 | STEEL A | 0.64 | Very Good | Good | INVENTIVE EXAMPLE |
| 26 | STEEL A | 0.63 | Very Good | Very Good | INVENTIVE EXAMPLE |
| 27 | STEEL A | 0.63 | Very Good | Very Good | INVENTIVE EXAMPLE |
| 28 | STEEL A | 0.63 | Very Good | Very Good | INVENTIVE EXAMPLE |
| 29 | STEEL A | 0.63 | Very Good | Very Good | INVENTIVE EXAMPLE |
| 30 | STEEL A | 0.64 | Very Good | Good | INVENTIVE EXAMPLE |
| 31 | STEEL A | 0.66 | Very Good | Good | INVENTIVE EXAMPLE |
| 32 | STEEL A | 0.67 | Poor | NG | COMPARATIVE EXAMPLE |
| 33 | STEEL A | 0.67 | Very Good | Poor | COMPARATIVE EXAMPLE |
| 34 | STEEL A | NOT EVALUATED | NOT EVALUATED | NOT EVALUATED | COMPARATIVE EXAMPLE |
| 35 | STEEL B | 0.63 | Very Good | Very Good | INVENTIVE EXAMPLE |
| 36 | STEEL C | 0.63 | Very Good | Very Good | INVENTIVE EXAMPLE |

TABLE 20

| | | EVALUATION RESULTS | | | |
|---|---|---|---|---|---|
| | | | COATING ADHESION | | |
| | | | CYLINDER | CYLINDER | |
| | | IRON LOSS | WITH | WITH | |
| | | W17/50 | 20 mm OF | 15 mm OF | |
| | | W/kg | DIAMETER | DIAMETER | NOTE |
| 37 | STEEL D | 0.63 | Very Good | Very Good | INVENTIVE EXAMPLE |
| 38 | STEEL E | 0.63 | Very Good | Very Good | INVENTIVE EXAMPLE |
| 39 | STEEL F | 0.63 | Very Good | Very Good | INVENTIVE EXAMPLE |
| 40 | STEEL G | 0.63 | Very Good | Very Good | INVENTIVE EXAMPLE |
| 41 | STEEL H | 0.63 | Very Good | Very Good | INVENTIVE EXAMPLE |
| 42 | STEEL I | 0.63 | Very Good | Very Good | INVENTIVE EXAMPLE |
| 43 | STEEL J | 0.63 | Very Good | Very Good | INVENTIVE EXAMPLE |
| 44 | STEEL K | 0.63 | Very Good | Very Good | INVENTIVE EXAMPLE |
| 45 | STEEL L | 0.63 | Very Good | Very Good | INVENTIVE EXAMPLE |
| 46 | STEEL M | 0.63 | Very Good | Very Good | INVENTIVE EXAMPLE |
| 47 | STEEL N | 0.63 | Very Good | Very Good | INVENTIVE EXAMPLE |
| 48 | STEEL O | 0.63 | Very Good | Very Good | INVENTIVE EXAMPLE |
| 49 | STEEL A | 0.63 | Very Good | Very Good | INVENTIVE EXAMPLE |
| 50 | STEEL A | 0.63 | Very Good | Very Good | INVENTIVE EXAMPLE |
| 51 | STEEL A | 0.63 | Very Good | Very Good | INVENTIVE EXAMPLE |
| 52 | STEEL A | 0.63 | Very Good | Very Good | INVENTIVE EXAMPLE |
| 53 | STEEL A | 0.63 | Very Good | Very Good | INVENTIVE EXAMPLE |
| 54 | STEEL A | 0.63 | Very Good | Very Good | INVENTIVE EXAMPLE |

TABLE 21

| | | EVALUATION RESULTS | | | |
|---|---|---|---|---|---|
| | | | COATING ADHESION | | |
| | | | CYLINDER | CYLINDER | |
| | | IRON LOSS | WITH | WITH | |
| | | W17/50 | 20 mm OF | 15 mm OF | |
| | | W/kg | DIAMETER | DIAMETER | NOTE |
| 55 | STEEL A | 0.63 | Very Good | Very Good | INVENTIVE EXAMPLE |
| 56 | STEEL A | 0.63 | Very Good | Very Good | INVENTIVE EXAMPLE |
| 57 | STEEL A | 0.63 | Very Good | Very Good | INVENTIVE EXAMPLE |
| 58 | STEEL A | 0.63 | Very Good | Very Good | INVENTIVE EXAMPLE |
| 59 | STEEL A | 0.63 | Very Good | Very Good | INVENTIVE EXAMPLE |
| 60 | STEEL A | 0.63 | Very Good | Very Good | INVENTIVE EXAMPLE |
| 61 | STEEL A | 0.63 | Very Good | Very Good | INVENTIVE EXAMPLE |
| 62 | STEEL A | 0.63 | Very Good | Very Good | INVENTIVE EXAMPLE |
| 63 | STEEL A | 0.63 | Very Good | Very Good | INVENTIVE EXAMPLE |
| 64 | STEEL A | 0.64 | Very Good | Very Good | INVENTIVE EXAMPLE |
| 65 | STEEL A | 0.63 | Very Good | Very Good | INVENTIVE EXAMPLE |
| 66 | STEEL A | 0.63 | Very Good | Very Good | INVENTIVE EXAMPLE |
| 67 | STEEL A | 0.64 | Very Good | Very Good | INVENTIVE EXAMPLE |
| 68 | STEEL A | 0.64 | Very Good | Very Good | INVENTIVE EXAMPLE |
| 69 | STEEL A | 0.63 | Very Good | Very Good | INVENTIVE EXAMPLE |
| 70 | STEEL A | 0.64 | Very Good | Very Good | INVENTIVE EXAMPLE |
| 71 | STEEL A | 0.64 | Very Good | Very Good | INVENTIVE EXAMPLE |
| 72 | STEEL A | 0.65 | Very Good | Very Good | INVENTIVE EXAMPLE |
| 73 | STEEL A | 0.64 | Very Good | Very Good | INVENTIVE EXAMPLE |

### INDUSTRIAL APPLICABILITY

According to the above aspects of the present invention, it is possible to provide the grain-oriented electrical steel sheet excellent in the adhesion of the insulation coating even without the forsterite film. Accordingly, the present invention has significant industrial applicability.

### REFERENCE SIGNS LIST

1 Base steel sheet (Silicon steel sheet)
2 Intermediate layer (Oxide film)
3 Insulation coating (Phosphate-based coating)
31 Internal region
31a First internal region
31b Second internal region
32 Surface region

1. A grain-oriented electrical steel sheet comprising:
a base steel sheet which is a silicon steel sheet;
an intermediate layer arranged in contact with the silicon steel sheet; and
an insulation coating arranged in contact with the intermediate layer,
wherein the intermediate layer is an oxide film satisfying:
20 atomic % or more and 70 atomic % or less of a Si content;
30 atomic % or more and 80 atomic % or less of an O content;
less than 20 atomic % of a Mg content;
less than 5 atomic % of a P content; and
less than 20 atomic % of a Fe content, and
an average thickness of the oxide film is 2 nm or more and 500 nm or less,
wherein the insulation coating is a phosphate-based coating satisfying:
5 atomic % or more and 30 atomic % or less of a P content;
5 atomic % or more and 30 atomic % or less of a Si content;
30 atomic % or more and 80 atomic % or less of an O content;
1 atomic % or more and less than 25 atomic % of a Fe content;
less than 1.0 atomic % of a Cr content;
0 atomic % or more and 10 atomic % or less of an Al content;
0 atomic % or more and 10 atomic % or less of a Mg content;
0 atomic % or more and 10 atomic % or less of a Mn content;
0 atomic % or more and 10 atomic % or less of a Ni content;
0 atomic % or more and 10 atomic % or less of a Zn content;
0.1 atomic % or more and 10 atomic % or less in total content of Al, Mg, Mn, Ni, and Zn;
0 atomic % or more and 10 atomic % or less of a V content;
0 atomic % or more and 10 atomic % or less of a W content;
0 atomic % or more and 10 atomic % or less of a Zr content;
0 atomic % or more and 10 atomic % or less of a Co content;
0 atomic % or more and 10 atomic % or less of a Mo content; and
0.1 atomic % or more and 10 atomic % or less in total content of V, W, Zr, Co, and Mo, and
an average thickness of the phosphate-based coating is 0.1 μm or more and 10 μm or less, and
wherein the phosphate-based coating includes a first crystalline phosphorus oxide whose crystal structure corresponds to Fe₂P₂O₇ and a second crystalline phosphorous oxide whose crystal structure corresponds to Fe₂(P₂O₇)+, and
the second crystalline phosphorous oxide includes at least one of V, W, Zr, Co, and Mo.

2. The grain-oriented electrical steel sheet according to claim 1, wherein
when the phosphate-based coating is divided along a thickness direction on a cross section whose cutting direction is parallel to the thickness direction into two equal regions which are an internal region in contact with the oxide film and a surface region not in contact with the oxide film,
a total area fraction of the first crystalline phosphorus oxide and the second crystalline phosphorous oxide which are included in the internal region is more than a total area fraction of the first crystalline phosphorus oxide and the second crystalline phosphorous oxide which are included in the surface region.

3. The grain-oriented electrical steel sheet according to claim 2, wherein
the total area fraction of the first crystalline phosphorus oxide and the second crystalline phosphorous oxide which are included in the surface region is 0% or more and 30% or less, and the total area fraction of the first crystalline phosphorus oxide and the second crystalline phosphorous oxide which are included in the internal region is 3% or more and 50% or less.

4. The grain-oriented electrical steel sheet according to claim 2, wherein
when the internal region is divided along the thickness direction on the cross section into two equal regions which are a first internal region in contact with the oxide film and a second internal region not in contact with the oxide film,
when a first area ratio is set as a percentage of a value obtained by dividing an area fraction of the second crystalline phosphorous oxide which is included in the first internal region by a total area fraction of the first crystalline phosphorus oxide and the second crystalline phosphorous oxide which are included in the first internal region, and
when a second area ratio set as is a percentage of a value obtained by dividing an area fraction of the second crystalline phosphorous oxide which is included in the second internal region by a total area fraction of the first crystalline phosphorus oxide and the second crystalline phosphorous oxide which are included in the second internal region,
the second area ratio is more than the first area ratio.

5. The grain-oriented electrical steel sheet according to claim 4, wherein
the first area ratio is 0% or more and 70% or less and the second area ratio is 50% or more and 100% or less.

6. The grain-oriented electrical steel sheet according to claim 1, wherein
an equivalent circle diameter of the second crystalline phosphorous oxide is 5 nm or more and 300 nm or less on average.

7. The grain-oriented electrical steel sheet according to claim 3, wherein
when the internal region is divided along the thickness direction on the cross section into two equal regions which are a first internal region in contact with the oxide film and a second internal region not in contact with the oxide film,
when a first area ratio is set as a percentage of a value obtained by dividing an area fraction of the second crystalline phosphorous oxide which is included in the first internal region by a total area fraction of the first crystalline phosphorus oxide and the second crystalline phosphorous oxide which are included in the first internal region, and
when a second area ratio set as is a percentage of a value obtained by dividing an area fraction of the second crystalline phosphorous oxide which is included in the second internal region by a total area fraction of the first crystalline phosphorus oxide and the second crystalline phosphorous oxide which are included in the second internal region,
the second area ratio is more than the first area ratio.
